(19) United States
(12) Patent Application Publication
(10) Pub. No.: US 2026/0313763 A1
(43) Pub. Date: Oct. 8, 2026

(54) SYSTEMS AND METHODS FOR COLLECTION OF HYDROCARBON COMPOSITIONS

(71) Applicant: A. Lawrence Berry, Houston, TX (US)

(72) Inventor: A. Lawrence Berry, Houston, TX (US)

(21) Appl. No.: 18/877,769

(22) PCT Filed: Nov. 22, 2024
(86) PCT No.: PCT/US2024/057182

§ 371 Date: Dec. 20, 2024

Related U.S. Application Data
(60) Provisional application No. 63/601,995, filed on Nov. 22, 2023.
(60) Provisional application No. 63/682,616, filed on Aug. 13, 2024.

(51) Int. Cl. H05B 6/72

(52) U.S. Cl. CPC H05B 6/72

(57) ABSTRACT

Systems, related components, and methods are described for collecting highly viscous hydrocarbon compositions from a standing surface pool or reservoir of hydrocarbon material. A collection conduit including a head unit may be disposed under the surface of the reservoir and microwave radiation may be used to change the viscosity of the material around an inlet. The head unit may include an array of magnetrons disposed about the inlet.

### CROSS REFERENCE TO RELATED APPLICATIONS

This application claims priority to each of US Provisional Patent Application No. 63/601,995 titled, “Systems and Methods for Collection of Hydrocarbon Compositions” filed Nov. 22, 2023, and US Provisional Patent Application No. 63/682,616 titled, “Systems and Methods for Collection of Hydrocarbon Compositions” filed Aug. 13, 2024. The foregoing applications are fully incorporated herein by reference.

### FIELD

This disclosure generally relates to systems and methods for the collection of heavy hydrocarbon compositions, including those that are difficult to collect using a suction pump without altering their physical or chemical properties.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

In some parts of the world, naturally occurring surface pools or reservoirs of heavy hydrocarbon materials have been found. These naturally occurring reservoirs may generally be formed when subterranean hydrocarbon deposits seep to the surface through factures in the earth or through porous rock. Exposed pools of such materials may generally thicken as more volatile material evaporates so that the viscosity of the remaining composition increases. Such compositions may be characterized as liquid or semi-liquid compositions, often highly heterogenous in nature, with a viscosity making them ill suitable for collection without modification.

Cost effective means for recovery of these materials has proven difficult. It would be beneficial to provide cost-effective systems and methods for recovery of these and other heavy hydrocarbon material.

### SUMMARY

In some embodiments, a machine may be configured for collecting hydrocarbon material from a standing pool or reservoir including a highly viscous hydrocarbon composition. The machine may include a vehicle including a boom having a first end and a second end, the boom being coupled to the vehicle at the first end and a collection conduit including a head unit, the head unit being coupled to the second end of the boom. The head unit may include an intake portion of the collection conduit including an inlet and a source of microwave radiation disposed to provide microwave radiation for heating material in a zone about the inlet when the head unit is positioned within a reservoir including a hydrocarbon composition.

In some embodiments, a system for collecting a hydrocarbon composition may include a boom having a first end and a second end and a collection conduit including a head unit, the head unit being coupled to the second end of the boom. The head unit may include an intake portion of the collection conduit including an inlet and a source microwave radiation disposed at a position for providing microwave radiation for heating material in a zone about the inlet when the inlet is positioned within a reservoir including the hydrocarbon composition.

In some embodiments, a system for collecting a hydrocarbon composition may include a mounting arm having a first end and a second end; a collection conduit including a head unit, the head unit being coupled to the second end of the mounting arm. The head unit may include an intake portion of the collection conduit including an inlet and a source microwave radiation disposed at a position for providing microwave radiation for heating material in a zone adjacent to the inlet when the inlet is positioned within a reservoir including said hydrocarbon composition.

In some embodiments, a head unit for a collection conduit may include a frame configured for coupling to a boom; an intake conduit in fluid communication with a hydraulic pump; and a plurality of magnetrons mounted to the frame, each magnetron having a waveguide or antenna oriented to direct microwave energy toward a zone near the intake conduit.

In some embodiments, a head unit for a collection conduit may include a frame; an intake conduit including an inlet, the intake conduit being in fluid communication with a hydraulic pump; and a plurality of magnetrons mounted to the frame, the plurality of magnetrons being positioned about said inlet so that microwave radiation emitted from the plurality of magnetrons may be provided about the inlet.

In some embodiments, a method of in situ extraction of hydrocarbons from a reservoir including a ground-surface pool of viscous hydrocarbon material may include disposing a collection conduit so that a head unit of the collection conduit is positioned under the surface of said ground-surface pool of viscous hydrocarbon material, the head unit including an inlet for collection of hydrocarbon material therethrough. The method may further include using a first set of conditions, heating material to provide a heating zone at or near the inlet using microwave energy, the heating of material being used to decrease the viscosity of said hydrocarbon material within said heating zone; collecting hydrocarbon material from the heating zone using the first set of material collection conditions and monitoring at least one metric of collection efficiency for collection of said hydrocarbon material; and executing a protocol for adjusting an applied set of material collection conditions if monitoring of the at least one metric of collection efficiency reveals that a threshold condition has been met.

In some embodiments, a system for collecting hydrocarbons may include an intake pump having an intake conduit coupled thereto; a plurality of magnetrons disposed about the intake head and oriented to direct microwave energy toward a zone of intake fluid near the intake conduit; a power supply configured to provide power to the plurality of magnetrons; a temperature sensor disposed near the intake head, the temperature sensor configured to provide a temperature signal indicating the temperature of the intake fluid; and a controller configured to receive the temperature signal and control the power supply so as to regulate power to the magnetrons based on the temperature signal.

In some embodiment, a method of in situ extraction of hydrocarbons from a surface pool of hydrocarbons may include lowering a pump head into a surface pool of hydrocarbons, the pump head comprising an intake conduit and a plurality of magnetrons; heating the hydrocarbons near the intake conduit using microwave energy from the magnetrons; removing the heated hydrocarbons from the surface pool by use of the pump head; and moving the pump head in the surface pool.

### BRIEF DESCRIPTION OF THE DRAWINGS

FIG. 1 is a side elevational view of an exemplary embodiment of a material collection system including a vehicle having a boom and a collection conduit with a head unit coupled thereto. In FIG. 1, the vehicle is adjacent a material reservoir and with the head unit at a first position in the reservoir.

FIG. 2 is another side elevational view of the material collection system of FIG. 1. In FIG. 2 the vehicle is adjacent a material reservoir and with the head unit at a second position in the reservoir.

FIG. 3A a side elevational view of another embodiment of a material collection system including a vehicle with a boom and a head unit a collection conduit assembly positionable using the boom. At least a part of the collection conduit assembly is supported separately from the boom.

FIG. 3B a side elevational view of another embodiment of a material collection system including a vehicle with a boom and a head unit a collection conduit assembly positionable using the boom. At least a part of the collection conduit assembly is supported separately from the boom and provided from a spool.

FIG. 4A is a side elevational view of another embodiment of a material collection system with a head unit mounted to a mounting assembly and mounting arm. The conduit assembly therein connects to a storage tank.

FIG. 4B is a side elevational view of another embodiment of a material collection system with a head unit mounted to a mounting assembly and mounting arm. The conduit assembly therein connects to piping for material distribution.

FIG. 4C is a side elevational view of another embodiment of a material collection system with a head unit mounted to a mounting assembly and mounting arm. The conduit assembly therein is routed from a spool.

FIG. 5 is a side elevational view of an embodiment of a material collection vehicle.

FIG. 6 is a side elevational view of an embodiment of a head unit including a plurality of microwave emitters disposed about a suction inlet.

FIG. 7 is a bottom plan view of the head unit of FIG. 6.

FIG. 8 is a side elevational view of another embodiment of a head unit. The head unit of FIG. 8 includes projections configured for absorbing microwave radiation disposed about the suction inlet.

FIG. 9 is a bottom plan view of the head unit of FIG. 8.

FIG. 10 is a bottom plan view of another embodiment of a head unit. The head unit of FIG. 10 includes a plurality of apertures formed within a housing of a microwave emitter.

FIG. 11 is a bottom plan view of another embodiment of a head unit. The head unit of FIG. 11 includes waveguides coupled to microwave emitters as may be used for providing microwave radiation to different projections or ribs centered about a suction inlet.

FIG. 12 is a side elevational view of another embodiment of a head unit. The head unit of FIG. 12 includes a cage surrounding the inlet which may be heated.

FIG. 13 is a bottom plan view of the head unit of FIG. 12.

FIG. 14 is a side elevational view of another embodiment of a head unit. The head unit of FIG. 14 includes a cage surrounding the inlet which may be heated and shaped to help heat surrounding material in the vicinity of the cage.

FIG. 15 is a bottom plan view of the head unit of FIG. 14.

FIG. 16 is a bottom plan view of another embodiment of a head unit.

FIG. 17 is a bottom plan view of still another embodiment of a head unit. The head unit of FIG. 17 may include a microwave emitter including a housing configured for selective radiation of a suction inlet.

FIG. 18 is a bottom plan view of still another embodiment of a head unit. The head unit of FIG. 18 may be configured for selective heating of different parts of a cage surrounding a suction inlet.

FIG. 19 is a perspective view of another embodiment of a head unit and showing supporting structure to which the head unit may be secured.

FIG. 20A is a side view of the head unit of FIG. 19.

FIG. 20B is a bottom plan view of the suction inlet of the head unit of FIG. 19.

FIG. 20C is a bottom plan view of an alternative embodiment of a suction inlet.

FIG. 21 is a schematic diagram of an embodiment of a control system.

FIG. 22A shows another embodiment of a head unit in a first position in a method for executing lateral movements of the head unit.

FIG. 22B shows the head unit of FIG. 22A in a second position following execution of a lateral movement of the head unit.

FIG. 23A shows the head unit of FIG. 22A in a first position in a method for executing vertical movements within a reservoir.

FIG. 23B shows the head unit of FIG. 23A in a second position following execution of a vertical movement of the head unit.

FIG. 24A shows the head unit of FIG. 22A in a first position in a method for executing other movements within a reservoir.

FIG. 24B shows the head unit of FIG. 24A in a second position following execution of movements of the head unit.

FIG. 25 is a schematic diagram of an embodiment of a method for collecting a hydrocarbon composition from a surface pool or reservoir.

FIG. 26 is a schematic diagram of an embodiment of a method for controlling a system for collection of a hydrocarbon composition.

FIG. 27 is a schematic diagram showing a layer of silicon carbide deposited on an insulating layer of a component of a head unit.

### DETAILED DESCRIPTION

As used herein, the following terms should be understood to have the indicated meanings:

When an item is introduced by “a” or “an,” it should be understood to mean one or more of that item.

“Comprises” means includes but is not limited to.

“Comprising” means including but not limited to.

“Having” means including but not limited to.

This disclosure is generally directed to systems, methods, and related components thereof for collecting hydrocarbon compositions. The collection of hydrocarbon compositions as described herein may include use of microwave radiation for in situ heating and modification of at least the physical properties of a hydrocarbon composition. For example, in some embodiments, one or more microwave radiation emitters may be mounted to a collection unit or head unit such as may part of a collection conduit and mounted at one end thereof. The microwave emitters may, for example, be positioned in an array about a collection conduit's inlet and may be used to heat a zone of material centered about the inlet.

In some embodiments, systems and methods as described herein may be configured for efficient movement of at least part of a collection conduit. For example, a head unit of a collection conduit may be positioned in a reservoir including a hydrocarbon material so that hydrocarbon material may be collected by suction at a suction inlet of the head unit and routed for collection in a storage unit located above the surface of the reservoir. The collection conduit may be coupled to a material collection vehicle including an adjustable boom with at least the head unit of the collection conduit being secured thereto and positionable using the boom. Accordingly, the head unit of the collection conduit may be easily transported through movement thereof and placed within different regions of the reservoir. Movement of the head unit may, for example, be used to sample material present at different areas of the reservoir for testing of the feasibility of hydrocarbon material collection. Alternatively, a collection conduit or collection conduit assembly may be mounted to a movable and adjustable arm positioned on a platform or mounted in some other suitable way.

Movement of a collection conduit may, for example, be executed manually by an operator of a material collection vehicle (e.g., a hydraulic crawler crane) through movement or operation of the crane's boom. However, in some embodiments, movement of a collection conduit may be executed differently. For example, movement of a collection conduit may be executed as part of an automated protocol for moving or sweeping a head unit coupled thereto so as to map at least a part of a hydrocarbon containing reservoir. In some embodiments, a system may be used for controlling movement of a plurality of collection conduits as may be associated with a plurality of material collection vehicles or other material collection machines. For example, a system may coordinate activities from each of those vehicles or other machines and collect data therefrom so as to more fully map or characterize a pool or reservoir of hydrocarbon material. Systems herein may further make use of data collected from other means such as flying drones. Aggregate data collected from different data collection resources, drones, and other data may be used to more fully characterize a reservoir or pool including hydrocarbon material and to guide movement of collection conduits or head units of collection conduits for material collection. Generally, wherein movement of a collection conduit or head unit is described in this disclosure movements may be controlled manually by an operator, through an automated control system, or both.

In some embodiments, systems and methods as described herein may include a collection conduit or part of a collection conduit assembly including a head unit that is particularly configured for heating hydrocarbon material present in the vicinity of a suction inlet for the conduit. For example, in some embodiments, heating of hydrocarbon material may at least in part be achieved indirectly through intermediate absorption of radiation by a head unit of a collection conduit or through absorption of radiant energy by structures mounted thereto and positioned near to the inlet. For example, one or more structures mounted to a head unit (e.g., a housing or body forming a suction inlet of a head unit, a projection or rib disposed about the inlet, or a cage surrounding the inlet) may be made from or otherwise include a microwave absorbing material such as silicon carbide. Such structures may be heated through absorption of microwave radiation so that subsequent conductive heating of hydrocarbon material in the vicinity of the inlet may take place. Through this heating, the composition's viscosity may be reduced facilitating collection of hydrocarbon material by suction.

With this context given, description is now provided of several representative embodiments of systems for material collection. Particular embodiments may be configured for moving at least part of a collection conduit or collection conduit assembly (e.g., in some embodiments, at least the head units thereof may be configured for movement). Following this description, some particular embodiments of head units and other components of material collection systems, including, for example, associated control systems are described. Lastly, representative methods are described.

### SYSTEMS FOR COLLECTION OF HYDROCARBON COMPOSITIONS

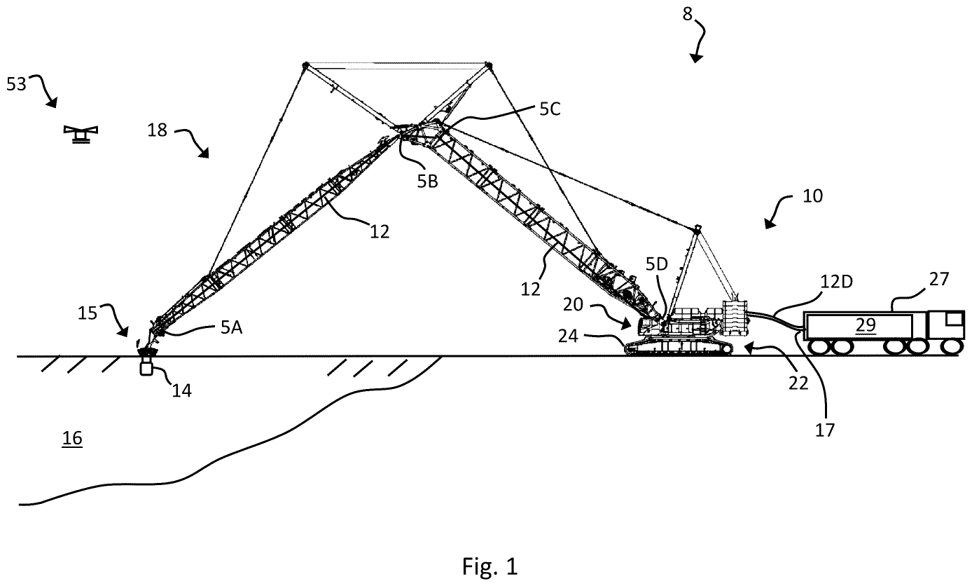

A first embodiment of a material collection system 8 is shown in FIG. 1. As shown therein, a collection conduit assembly 12 (sometimes referred to herein as conduit assembly 12) may be secured to a machine, such as a material collection vehicle 10. In the embodiment shown, the material collection vehicle 10 is embodied as a crawler crane and includes an adjustable boom 18. As generally understood in the art, a crawler crane may include a body or deck 20 mounted to an undercarriage 22. The undercarriage 22 of a crawler crane may include toothed wheels engaging a track 24 providing traction as may be necessary for use on soft or uneven ground. Accordingly, a crawler crane may generally embody a vehicle suitable for working around some of the collection sites described herein, including, for example, those which may demand movement nearby to the shoreline of a standing reservoir of hydrocarbon material. Notably, such a shoreline may sometimes be ill defined and the ground surrounding such reservoirs may be uneven or provide poor traction for a moving vehicles. Accordingly, in some embodiments, when preparing a site for material collection one or more stabilizing platforms or roads may be built prior to or during material collection. In some embodiments, any of various different vehicles or forms of mobile cranes may be used. For example, in some embodiments, different mobile cranes including, for example, rough terrain, all terrain, truck-mounted, spider, hydraulic, crawler, and side-lift cranes may be used. Generally, the vehicles may include a suitable body, such as the deck 20 of material collection vehicle 10, to which a boom may be coupled.

At least a part of conduit assembly 12 may be supported by and positioned using the boom 18. A head unit 14 may be disposed at a first end 15 of conduit assembly 12 so that it is also generally positioned at the distal end of the boom and may be positioned thereby. A second end of the conduit assembly 12 may be coupled to a storage tank 29, for example. For example, the storage tank 29 in the illustrated embodiment is part of the tank truck 27. At least one microwave radiation emitter (e.g., a klystron, magnetron, or other suitable emitter) may be integrated within the head unit 14 of the conduit assembly 12. The head unit 14 and its associated inlet (not shown in FIG. 1) may be positioned within an exposed reservoir 16 of a hydrocarbon composition, such as a pool of asphalt or tar. In some embodiments, data used for positioning of the head unit 14 may, for example, be provided using a drone 53. Alternatively, positioning of a head unit 14 may be based on data collected by other head units or vehicles and historical data for collection of hydrocarbons from the reservoir.

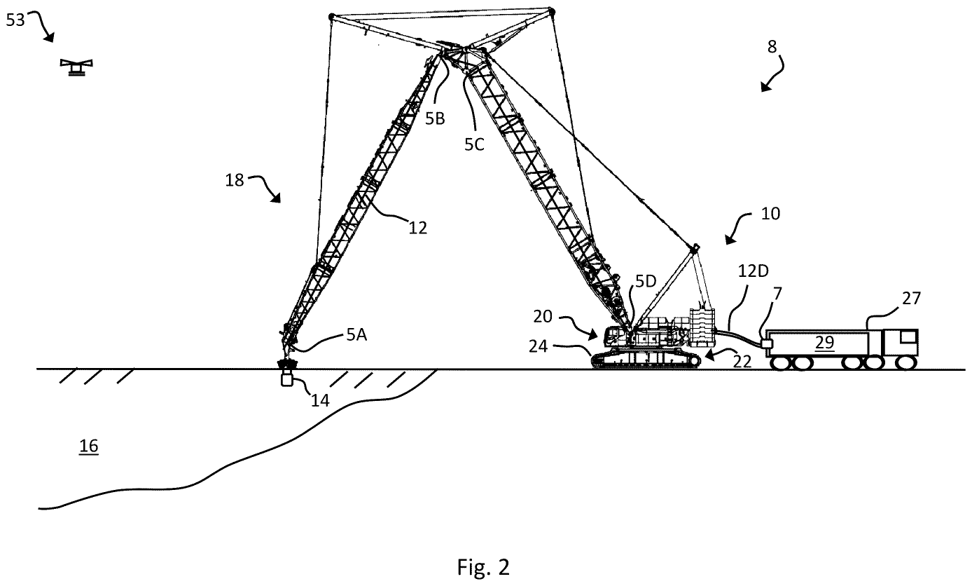

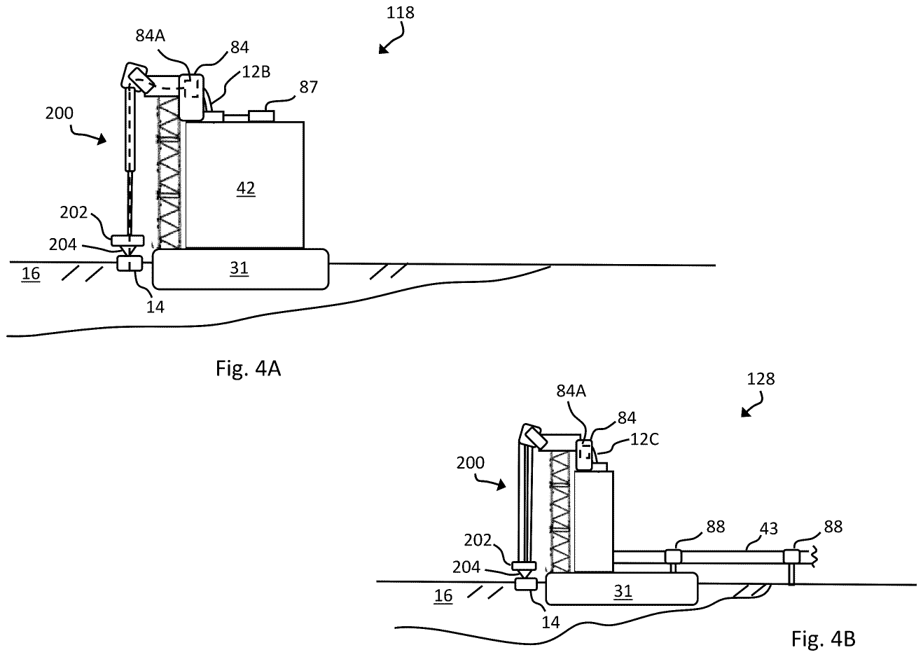

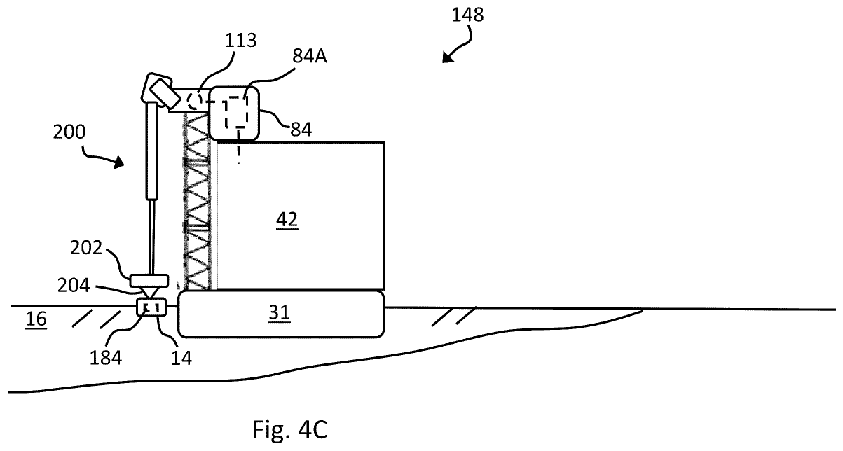

As shown in FIG. 1, a crawler crane or other suitable material collection vehicle 10 may be generally positioned along the shoreline of an exposed pool or reservoir 16 of a hydrocarbon composition and the boom 18 may then be used to position a head unit 14 and its associated inlet at a distance from the shoreline and within the reservoir 16. As an alternative to a crawler crane, a boom 18 may also be mounted to a different material collection vehicle. In other embodiments, a boom 18 may be mounted to a platform (see FIGS. 4A-4C, for example) such as one that may be fixed in place or moved in some way. The head unit 14 may be moved or swept across the reservoir 16. For example, as shown in FIG. 2, the head unit 14 is shown moved to a new region of the reservoir 16 by adjustment of the boom 18.

In some embodiments, conduit assembly 12 may be formed of any suitable construction so that it may move with the boom 18. For example, different parts or conduits of conduit assembly 12 may be formed of a flexible or flexibly extendable construction. Alternatively, if routed through a single collection conduit, at least a part of the conduit may be made of a flexible or flexibly extendable construction. For example, as also described herein (see, e.g., FIG. 5 and the associated description thereof) at least part of conduit assembly 12 may be made of a flexible or flexibly extendable construction so that the conduit assembly 12 may adjust as necessary to accommodate for movements of the boom. In some embodiments, shown in FIG. 1 and FIG. 2, one or more expansion joints 5A, 5B, 5C, 5D may be provided for conduit assembly 12 as may be positioned at different points along the boom 18. In some embodiments, expansion joints 5A, 5B, 5C, 5D may comprise flexible bellows joints. In one example, the joints 5A, 5B, 5C, 5D may be comprised of metal or rubber and may include a steel wire reinforcement frame. In one example, expansion joints 5A, 5B, 5C, 5D may be comprised of rubber including those made of natural or synthetic elastomeric components. The joints 5A, 5B, 5C, 5D may be universal bellows joints and may be configured for movement along any of a plurality of axes including along the axis of the collection conduit so as to allow for expansion or retraction, for example.

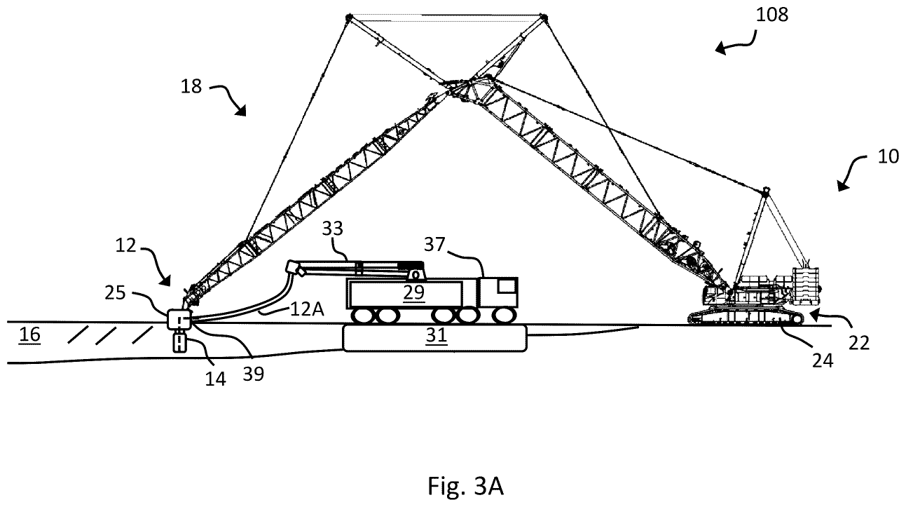

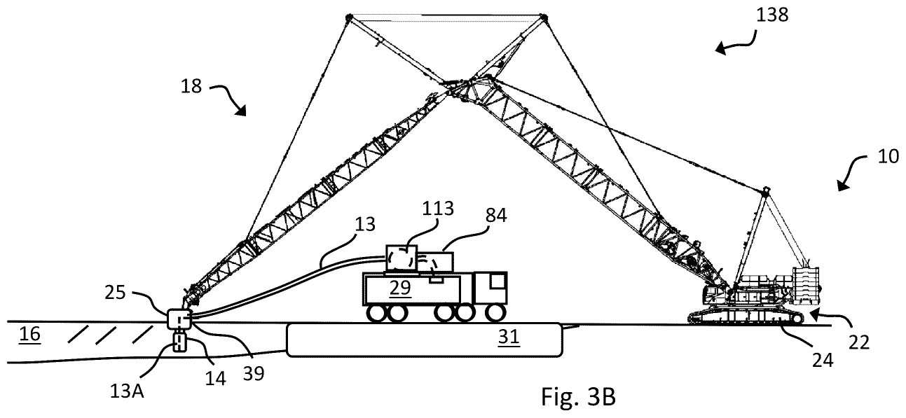

In some embodiments, the conduit assembly 12 may include a conduit spool from which conduit may be deployed and retracted as may be necessary to accommodate for movements of a boom or mounting arm. For example, each of FIG. 3B and FIG. 4A include a spool for routing at least a portion of a material collect conduit. In some embodiments, at least some portion of a collection conduit may be configured to be fed from a conduit spool. The collection conduit may further include one or more expansion joins, such as universal bellows expansion joints, for example.

Generally, a crawler crane as shown in FIG. 1 and FIG. 2 (or other suitable machine with a boom) may be used in embodiments wherein it is desirable to position the head unit 14 at a distance from the shoreline of a standing pool or lake 16. Of course, a crawler crane or other suitable vehicle or crane may include any of various components useful in extending the boom 18 at a distance from the shoreline of a reservoir 16 including, for example, appropriate counterweights and stabilizers or outriggers. In some embodiments, a crawler crane may include one or more attachments (such as a jib) as may sometimes be used to increase the reach of the boom 18 so as to reach further from the shoreline of a reservoir 16. Such reservoirs may include, for example, asphalt, tar, pitch, and other highly viscous hydrocarbon compositions. However, some embodiments herein may be used for collection of hydrocarbon compositions from other standing pools or reservoirs, and which may, alternatively, be described as semi-solid compositions or other liquid-solid hybrid compositions.

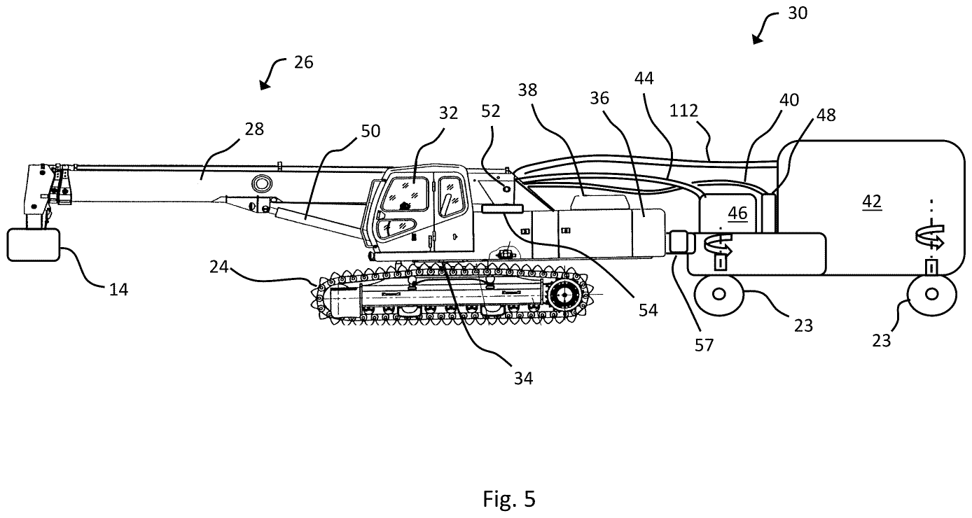

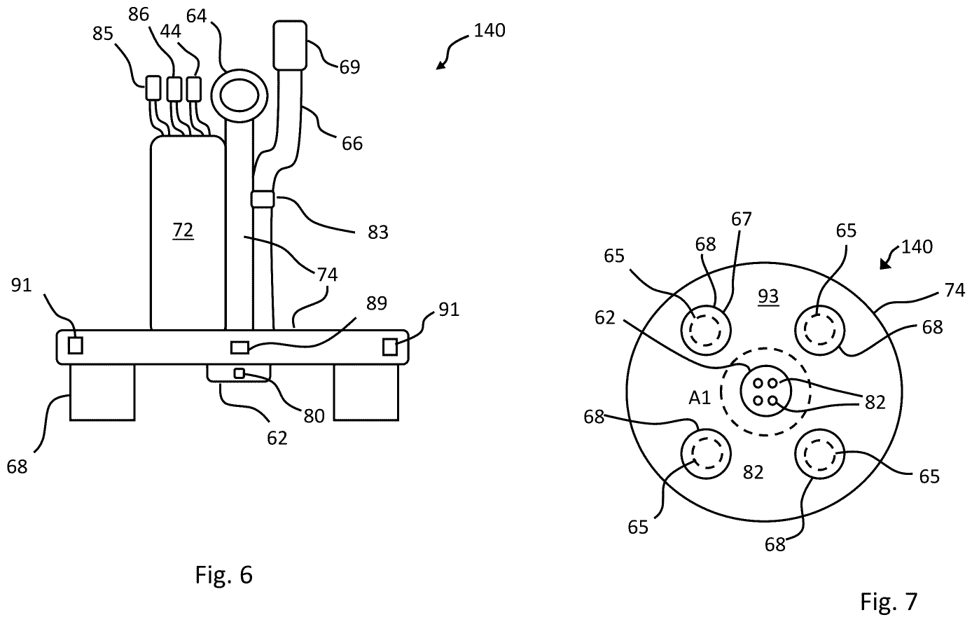

In some embodiments, the head unit 14 may be moved using available capabilities of the crawler crane such as through rotation or movement of the crane's body or adjustment of its boom 18. For example, the head unit 14 and thus the inlet of conduit assembly 12 may be moved when collection of material from a given region of the reservoir 16 is found to be deficient or when executing a routine for sampling different regions of a reservoir 16. As described further herein, a head unit 14 may include one or more sensors (see related head unit 140 of FIG. 6, for example) as may be used for collection of data suitable for identifying portions of a reservoir 16 generally suited for efficient material collection. Other sensors including, for example, imaging cameras may also be used to help map a reservoir 16. For example, an aerial drone 53 may be used to collect data useful when characterizing or mapping a reservoir. In some embodiments, a drone 53 may be configured for collection of reflectance spectral data for the reservoir. Gaseous emissions may also be mapped detected over different region of a pool or reservoir 16, as may, for example, be used to characterize regions of a reservoir 16 where generally lighter hydrocarbons may be present or where such hydrocarbons may be escaping from the reservoir.

In the collection system 8, at least a part of the conduit assembly 12 is supported by the boom 18 so that material collected at the head unit 14 may be routed towards the material collection vehicle 10. Material collection vehicle 10 (sometimes simply referred to as vehicle 10) may have a storage resource associated therewith. For example, material collection vehicle 10 may have a separate storage resource positioned in proximity thereto. At some point or juncture along the pathway of conduit assembly 12, material may be diverted towards the storage resource. For example, as shown in FIG. 1 and FIG. 2, collected hydrocarbon material may be routed through conduit 12D to a storage resource embodied as a storage tank 29, as may, for example, be part of a tank truck 27. In other embodiments, the material collection vehicle 10 itself may include a storage tank as may be mounted to its deck 20 or separately mounted to the deck 20 through a hitch connection, for example. In some embodiments, the material collection vehicle 10 may include the boom 18 and the collection conduit assembly 12 (including the head unit 14). The conduit 12D may include a connector 17 suitable for coupling the conduit assembly 12 to an appropriate storage or other system resource (such as the storage tank 29 in the illustrated embodiment). The connector 17 may be capped and the conduit 12D maintained or stored as convenient when the material collection vehicle 10 is not coupled to the tank truck 27 (or to another system resource).

In some embodiments, a conduit assembly 12 may be supported and routed to storage components (or other system components) differently. For example, a second embodiment of a collection system 108 is shown in FIG. 3A. As shown therein, conduit assembly 12 may be supported at least in part separately from the boom 18. For example, as shown in FIG. 3A, conduit assembly 12 may be routed to the storage tank 29 of the tank truck 37 through a connecting linkage or joint 25. The head unit 14 may still be connected to the boom 18 but the connecting linkage or joint 25 routes portions of conduit assembly 12 outside of its head unit 14 to a separate structure so that at least the majority of the conduit assembly 12 need not be supported by the boom 18. Rather, it may be supported by some other structure. For example, as shown in FIG. 3A, a portion 12A of conduit assembly 12 is secured at least in part using tank truck 37. Particularly, the portion 12A of the conduit is supported at least in part by the boom 33 of the tank truck 37 so that it may be routed through the boom 33 to the storage tank 29. As shown in FIG. 3A, tank truck 37 is shown supported on a platform 31. Of course, a collection system 108 could be configured differently. For example, as opposed to a tank truck 37 some other vehicle or structure could be used. In some embodiments, conduit assembly 12 may be routed through a connecting mount or joint 25 to a storage resource which may be positioned on a fixed platform or integrated as part of any of a barge, floating pontoon, scaffolding, rail, adjustable platform, or other fixed or movable structure, for example.

In some embodiments, at least a part of the conduit assembly 12 may be made of a flexible or flexibly extendable construction so that at least some movement of the boom 18 may be allowed without disconnecting portion 12A of conduit assembly 12 from the connecting mount or joint 25. In some embodiments, the portion 12A may be coupled to the linkage or joint 25 through a connector 39. Connector 39 may, for example, be configured so that portion 12A is reversibly coupled to the linkage or joint 25. Accordingly, the portion 12A of conduit assembly 12 may, for example, be decoupled or separated from the linkage or joint 25 as may be done when the head unit 14 is moved too great a distance to be easily accommodated for by the flexible or flexibly extendable construction of conduit assembly 12. The portion 12A (or a different conduit, as the case may be) may then be coupled back to the linkage or joint 25 after the head unit 14 has been moved to a new location or region of the reservoir 16. In some embodiments, the conduit assembly 12 may include a conduit spool form which conduit may be deployed and retracted as distance between the tank truck 37 and head unit 14 changes.

For example, FIG. 3B shows a third embodiment of a system 138 for material collection. As shown therein, in some embodiments, a collection conduit 13 may be routed from a spool 113. An adjustable length of collection conduit 13 may be provided from the spool 113 as necessary to accommodate for movements of the head unit 14. Thus, for example, a single collection conduit 13 may be routed from the head unit 14 through the spool 113 and to storage tank 29. A pump 84 may be used for applying necessary suction pressure so that material may be collected through the head unit 14. For example, suction applied at the inlet of head unit 14 may drive material collection through an intake portion 13A of the collection conduit 13 included in head unit 14.

As described above, in some embodiments, movement of a head unit 14 may be performed using a material collection vehicle 10 such as through movement of the boom 18 and/or movement of the vehicle 10 itself. However, in some embodiments, movement of a head unit 14 and thus the inlet of a conduit or conduit assembly 12 may be accomplished differently. For example, in some embodiments, movement of a head unit 14 may not require movement of the material collection vehicle 10 or adjustment of a boom 18.

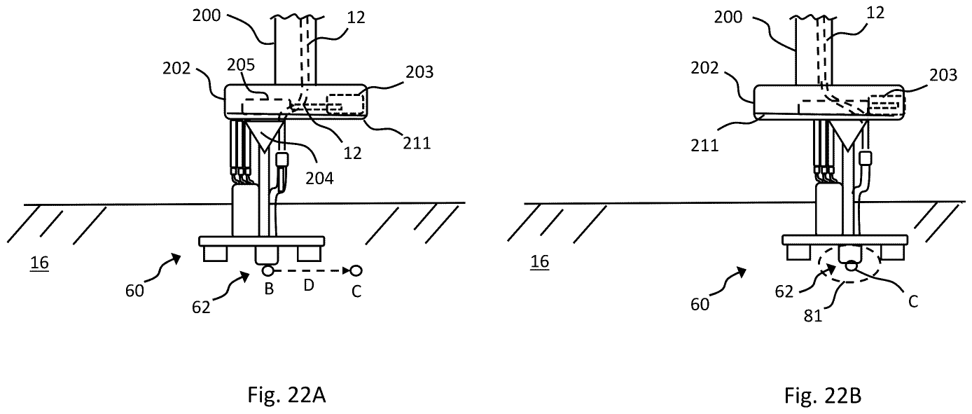

For example, FIG. 4A shows a fourth embodiment of a collection system 118. As shown therein, head unit 14 may be secured to a mounting arm 200 through a mounting assembly 202. The mounting assembly 202 (see also FIG. 22A and FIG. 22B), may allow for movement of a connector 204 (e.g., a hook or pin connection) independently from the mounting arm 200. Thus, for example, the head unit 14 may be swept or moved over a certain area without requiring movement of the mounting arm 200. Rather, movement of the head unit 14, may be achieved by moving the connector 204 so that the collection unit 14 connected thereto may be moved, rocked, or swept over at least some area of the reservoir. Other movements of the collection unit 14 (e.g., changes in depth) may, for example, be actuated using either or both of the mounting assembly 202 and mounting arm 200. Although shown in FIG. 4A as being coupled to the mounting arm 200, mounting assembly 202 may alternatively be connected to a boom, including, for example, any of the boom 18 as shown in FIGS. 1 & 2 or the boom 26 (shown in FIG. 5 and described below).

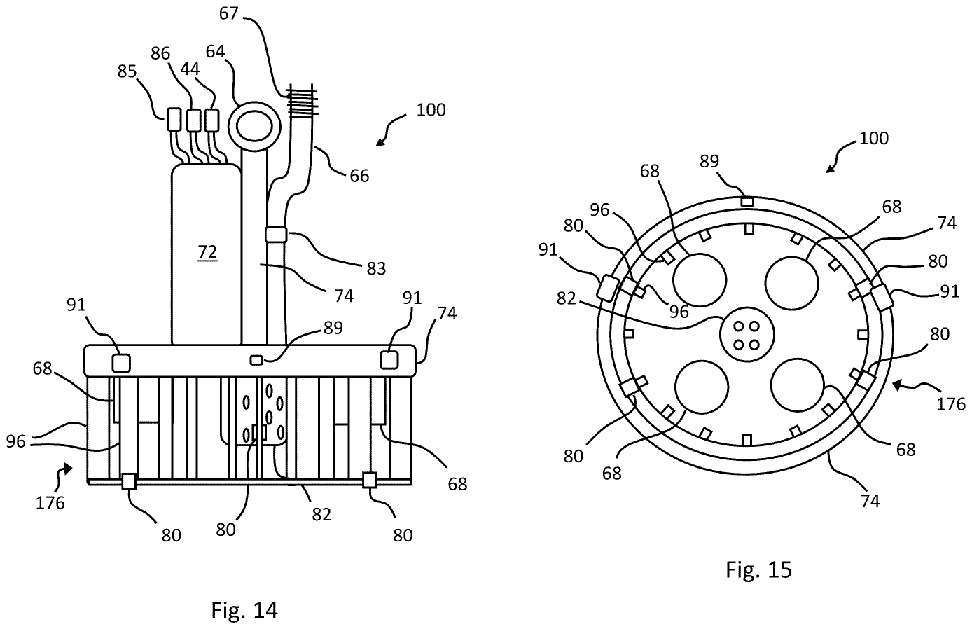

In some embodiments, material collected through the head unit 14 may be routed through each of mounting assembly 202 and mounting arm 200. For example, a collection conduit or conduit assembly may be routed through mounting assembly 202 (see also FIG. 14). At least a portion of the collection conduit or conduit assembly may flexibly extend as necessary to accommodate for movement of the mounting assembly 202 as it moves over its available range of travel. In some embodiments, a collection conduit 12B may be routed through mounting arm 200 and pass through surface pump 84 to the storage tank 42. Alternatively, as shown in FIG. 4B showing a fifth embodiment of a collection system 128, the collection conduit 12C may route to piping 43. Heating elements 86 may work to control the fluidity of collected material throughout at least a length of the piping 43. In some embodiments, piping 43 may route collected fluid from different material collection systems to a central terminal where tank trucks or other shipping resources may be disposed for distribution of the collected material.

A sixth embodiment of a material collection system 148 is shown in FIG. 4C. As shown therein, in some embodiments, a submersible pump 184 may be integrated within the head unit 14. Submersible pump 184 may operate as an alternative to surface pump 84. Alternatively, as shown in the illustrated embodiment, a combination of pumps 84, 184 may work to apply necessary pressure used for collection of material through an intake portion of a conduit or conduit assembly of the head unit 14. As also shown in FIG. 4C, a conduit or conduit assembly may provide additional suction conduit through the spool 113.

Thus, in situ heating of hydrocarbon compositions may include using microwave radiation for heating a central zone or region surrounding at least an inlet of a collection conduit or conduit assembly 12. However, additional heating may also be provided over at least some length of a collection conduit or conduit assembly or over other parts of a material collection system. For example, material already driven into a collection conduit may be heated so that it may remain suitably fluid for pumping. In some embodiments, heating may occur at least along a length of a collection conduit or conduit assembly as may be useful to establish consistent flow therethrough. This heating may include heating the composition through the suction inlet and upstream pump machinery. For example, heating may be provided at least through a pump chamber, as may demand a suitably fluid composition so as to maintain a desired pump pressure and avoid cavitation which could disrupt collection or damage pump machinery. For example, as shown in each of FIG. 4A and FIG. 4B, a surface pump 84 may be used to apply suction for collection of hydrocarbon material heated at the head unit 14. Heating may generally be provided at least through the pump chamber 84A. In some embodiments, one or more pumps 84 may also be coupled to a collection conduit or conduit assembly at other positions, including within the head unit 14, for example.

Generally, any of various procedures may be used to initiate suction collection of material using a pump 84, such as by priming the pump 84. This may, for example, include supplying a priming fluid at the suction inlet during initial stage of pumping. Importantly, some embodiments herein that involve movement of a suction inlet may be particularly configured so that they do not disrupt pump pressure while moving the conduit. For example, as described further herein, including in relation to FIG. 18, a head unit 130 with a heated suction inlet may be moved in a direction so that “preheated material” is disposed in a pathway of movement of the suction inlet. This may, for example, help to facilitate movement of a head unit 130 (or generic head unit 140, for example) to different regions of a reservoir 16 without allowing for cooler and more viscous material to displace heated material around a suction inlet during movement. Importantly, this may help to avoid a need for repriming of the pump 84 following movement and may further minimize risk of disruption of pump pressure such as may occur under some conditions leading to pump cavitation risking damage to pump components.

Thus, in some embodiments, collected hydrocarbon material may be heated at a suction inlet or surrounding areas of the inlet. Material may also be heated at other stages of collection or during other stages of the hydrocarbon material's lifecycle including, for example, during storage or transport of collected hydrocarbon material to a remote refining facility or other location where the material may be processed or in some cases used in substantially its natural form. For example, material may be collected into a storage tank and then transported to a remote facility using an insulated storage or shipping container (e.g., a drum, tote, storage chamber of a tanker or tank truck, or other chamber or reservoir of a vehicle) and may remain heated during storage or transport. In other embodiments, collected material may be allowed to cool so that the viscosity may sometimes increase during storage or transport. For example, the material may be placed within a drum, tote or other storage container and may be allowed to cool so that in some situations the material may solidify during storage and/or transport. Generally, heating of material at stages following in situ collection of hydrocarbon material may be accomplished by any suitable means such as using a resistive or radiative heater, for example.

In some embodiments, movement of a head unit 14 may be achieved using a combination of different mechanisms. For example, movement over a first area or region of a reservoir 16 (e.g., sweeping, rotating, rocking, or other movements) may be actuated using a mounting assembly 202 and controlled using a control system so that the movements, at least once initiated, may not require further input from a user. Such movements may, for example, be executed to probe a localized region of a reservoir 16 for finding an ideal position or identifying a sweeping or movement routine that may be used to enhance material collection. Other movements may require positioning of a head unit 14 or head region of a collection conduit to a much different area of the reservoir 16. Such movements may, for example, be accomplished through operation of a boom 18, 26 or movement of a material collection vehicle, such as the crawler crane shown in FIG. 1 & FIG. 2 or the crawler crane shown in FIG. 5, described below. This may, for example, be done manually by an operator of one of these crawler cranes. In some embodiments, a control system may guide a user to position a head unit 14 or a head portion of a collection conduit to a given area of a reservoir or to move the head unit 14 or head portion in a given direction. For example, a control system may provide position coordinates to an operator of a material collection vehicle 10, 30 (via an in cab display, for example) so as to guide the operator when moving the vehicle and/or positioning a boom 18, 26.

FIG. 5 is a side view of a seventh embodiment of a material collection system. As shown in FIG. 5, the material collection system may comprise a material collection vehicle 30. In some embodiments, for example, all necessary components of a material collection system for extraction and routing of material from a head unit 14 to a storage unit 42 may be self-contained as a “stand-alone” material collection vehicle 30 (as again shown in an exemplary manner as embodied in a crawler crane). For example, the storage unit 42 may be mounted to a deck 34 of the material collection vehicle 30 so that the storage unit 42 may rotate along with the deck 34. Alternatively, the storage unit 42 may be removably coupled to the deck 34 through a hitch connector 57 such as may be of a pivoting style that adjusts accordingly so as to allows for the deck to rotate at least over some range of rotation. Wheels 23 may likewise be mounted for rotation.

Generally, the material collection vehicles 10, 30 may share different features described in either of the two embodiments. For example, material collection vehicle 30 explicitly shows a boom 26 configured for telescopic extension. However, one or more sections of boom 18 may also be configured for telescopic extension. The boom 26 may generally include a plurality of boom sections nested together. For example, a first boom section 28 may be configured to slidably receive a second boom section so that the second boom section is nested or tucked within the first boom section 28 and so generally obscured from view when the boom 26 is in the retracted position, as shown in FIG. 5. In some embodiments, collection conduit 112 may be disposed at least in part within the boom 26. Collection conduit 112 may further extend to a storage tank 42, generally positioned at the distal side of material collection vehicle 30.

More generally, collection conduit 112 may provide communication of collected material from its suction inlet (see, e.g., suction inlet 62 of related head unit 140, shown, respectively, in FIGS. 6 & 7, for example, which may be substituted for head unit 14 in either of the material collection vehicles 10, 30) to a storage tank 42 or alternatively to some other system facility. In some embodiments, at least a part of the collection conduit 112 may be made from a flexible and/or a flexibly extendable hosing or tubing, such as may be embodied in the form of a bellows tubing, for example.

In some embodiments, at least a portion of the collection conduit 112 may be a steel wire reinforced suction hose comprising multiple reinforced layers. In other examples, collection conduit 112 may be configured differently or made with some other suitable material (e.g., one with suitable strength, flexibility, and durability). The collection conduit 112 may generally be configured to bend or extend as may be necessary so that the collection conduit 112 may move with the boom 26. For example, the collection conduit 112 may be secured to the boom 26 using one or more straps, mounts, or brackets. Accordingly, movement or extension of a boom 18, 26 may be translated to movement of the collection conduit 112. Flexibly extendable portions of the collection conduit 112 may, for example, adjust to a degree of extension as necessary during boom extension or retraction.

As shown in FIG. 5, the material collection vehicle 30 may further include a cab 32, a deck 34 (as may be equipped with rotating capabilities), one or more counterweights 36, a power source 38 (e.g., an engine or motor), a generator 46, and a chiller 48. Power resources may, for example, be provided to the collection unit 14 from generator 46 through power line 44. Cooling liquid may be provided to the collection unit 14 from chiller 48 through circulation line 40 (as may include a bundled input chill water line and a return line). Generally, boom 26 may be mounted in any of various ways allowing for its movement and positioning. For example, as shown in FIG. 5, boom 26 may, in some embodiments, be mounted to the body of material collection vehicle 30 through a rotatable turret 54. A joint, such as knuckle joint 52, be mounted to the rotatable turret 54. Boom 26 may generally move about the knuckle joint 52, which, as understood in the art, may support movement of the boom 26 in various directions. Actuation of the boom 26 (e.g., rotation from side to side or pivoting up and down) may, for example, be driven by rotatable turret 54 and hydraulic cylinder 50. Telescopic extension and retraction of the boom may be controlled using one or more additional hydraulic actuators (not shown in FIG. 5), such as may be mounted internally within the boom 26. Alternatively, actuators (e.g., hydraulically controlled cylinders) suitably configured to drive telescopic extension and/or retraction may be mounted to an exterior housing of the boom 26.

As shown in each of the systems 8, 30, 108, 118, 128, 138, 148 a collection conduit 112 or conduit assembly 12 may be coupled to what may be considered a generic head unit 14. For example, a head unit 14 may be mounted to either of the material collection vehicles 10, 30. Alternatively, a head unit 14 may be mounted to a mounting assembly 202 or to other structures as described herein. Generally, unless the context indicates otherwise, in some embodiments, other head units as described below may be substituted for the head unit 14 in any of the systems 8, 30, 108, 118, 128, 138, 148 or other systems as described herein.

### HEAD UNITS AND OTHER COMPONENTS OF MATERIAL COLLECTION SYSTEMS

Generally, the head units as described herein may be configured for in situ heating of a hydrocarbon composition disposed at least within a central zone around the suction inlet of a collection conduit. In situ heating of a hydrocarbon composition may be provided through various mechanisms including, for example, directly through absorbance of electromagnetic radiation by the hydrocarbon composition. This absorbance may, for example, be mediated through interactions between microwave radiation and residual components included in the hydrocarbon composition, such as microwave absorbing water, or other dielectric components present therein. In situ heating of a hydrocarbon composition may also occur indirectly by heating of a microwave absorbing material forming a part of a collection conduit or forming at least a part of nearby or adjacent structures thereto and through transfer of energy from the microwave absorbing material to the hydrocarbon composition via conduction. In some embodiments, a fluid such as a pump priming fluid or other fluid may also be added to or mixed with a hydrocarbon composition such as may help to facilitate additional absorption of radiant energy or to help facilitate diffusion and corresponding distribution of thermal energy. As further described herein, in some embodiments herein, a head unit may be configured so as to promote in situ heating of hydrocarbon composition (also referred to as a hydrocarbon material) via any one of the above mechanisms or combinations of mechanisms as described above.

For example, in some embodiments, to facilitate indirect heating of a hydrocarbon composition, at least a part of a head unit may be made from or otherwise include a microwave absorbing material such as silicon carbide (SiC) (or a composite formed thereof). Silicon carbide or a similar microwave absorbing material may, for example, make up or may be included in any of various structures disposed about or near to a suction inlet of a head unit including, for example, any of an outer face of the head unit, one or more projections or ribs, and a cage or cage-like structure surrounding the inlet. In some embodiments, the suction inlet itself may be comprised of silicon carbide or another microwave absorbing material.

In some embodiments, silicon carbide may make up the structure or body of a component made therefrom. For example, silicon carbide may, in some embodiments, be formed as a material such as a composite material possessing physical properties (e.g., density, hardness, and durability) so as to make it suitable for use in component fabrication. However, silicon carbide may also be added as an absorbing layer or coating making up a surface of a given component or structure. In some such embodiments, it may be useful to form a component made of or otherwise including silicon carbide as a coating deposited on another material, such as a material that does not readily conduct heat. Alternatively, a layer of an insulator may be disposed between a silicon carbide coating and a material upon which it is supported. For example, as shown in FIG. 27, an insulating layer 3 may be provided between a silicon carbide coating 4 and a bulk portion of a component of a head unit. Accordingly, energy absorbed by silicon carbide may generally not be spread or dissipated into the surface of the material but rather may stay available for heating of external material in its vicinity. More generally, in some embodiments herein wherein silicon carbide or another microwave absorbing material is used for making or otherwise included in a component the material may be integrated in the component in a way so as to facilitate heating of hydrocarbon material adjacent to the component.

For example, an embodiment of a head unit 140 which may be made, at least in part, from silicon carbide or another microwave absorbing material is shown in FIG. 6 and FIG. 7. FIG. 6 shows a side elevational view of the head unit 140. FIG. 7 is a bottom plan view of the head unit of 140. As shown in FIG. 7, at least the outer face 93 of the head unit 140 may be made of a microwave absorbing material such as silicon carbide. However, in some embodiments, the entire support frame 74 may be made of or otherwise include silicon carbide. One or more microwave emitters such as magnetrons 68 may be secured to the outer face 93 of the head unit 140. For example, as shown in FIG. 7, a group of four magnetrons 68 may be positioned in an array about the suction inlet 62. However, in other embodiments, some other number of microwave radiation emitters, such as between one to eight microwave radiation emitters, may be included in a head unit 140. Microwave radiation may be emitted from the magnetrons 68 so that radiation intensity may be provided within a central zone A₁ generally centered about the suction inlet 62. For example, in some embodiments, microwave radiation may be uniformly emitted outwards from one or more antenna 65 provided in each of the magnetrons 68. For example, each magnetron may have a housing 67 that may be made from microwave transmissive materials so that microwaves may be provided throughout a relatively wide zone of material surrounding the head unit 140. A particularly high intensity of radiation may be directed near the suction inlet 62 between the array of microwave radiation emitters or magnetrons 68.

As further shown in FIG. 6 and FIG. 7, head unit 140 may also include, among other additional structures, a connector or mount 64, a suction hose 66, a hose connector 69, a chase 72, and one or more sensors 80, 83, 89, 91. Power may be received into the head unit 140 through power line 44. Respectively, input fluid line 85 and return fluid line 88 may provide cooling liquid for circulation about the magnetrons 68 or other internal components that may need cooling. For example, cooling liquid may be circulated about power distribution components (e.g., transformers and capacitors) included with the magnetrons 68. A suitable housing may also be provided so as to protect components of the head unit 140 that are not normally meant to be in contact with the environment of a reservoir 16. Generally inlet 62 provides an opening through which heated hydrocarbon material may be collected through suction. For example, as shown in FIG. 7, the inlet 62 may be a perforated inlet, such as may include a plurality of openings 82. Various sensors 80, 83, 89, 91 may be included on the sensor head including, for example, temperature sensor 80, flow sensor 83, GPS sensor 89 and depth control sensor 91.

Generally, the connector 64 may be configured for securing the head unit 140 to a supporting structure (such as a boom 18, 26, mounting arm 200, or other suitable structure) of any of the material collection systems 8, 30, 108, 118, 128, 138, 148 as described herein. The head unit 140 may be secured in place but configured so that the head unit 140 may be releasable from the structure to which it is mounted so that the coupling therebetween may sometimes be referred to as being a releasably secured coupling. Thus, advantageously, the collection unit 140 may sometimes comprise a distinct part of a material collection system that may be easily separated from a boom or other structure to which it is mounted and repaired or replaced if needed. In some embodiments, connector or mount 64 may be embodied in the form of a ring eyelet or a pin connector, for example. Accordingly, the connector or mount 64 may be secured to a hook, for example. Of course, a connector or mount 64 may be paired with other means for securing a collection unit 140 to structure to which it is mounted. For example, one or more locking chains may be used to help secure the collection unit 140 to a boom 18, 26 (as shown in FIGS. 1, 2 and 5), mounting assembly 202 (as shown in FIGS. 4A and 4B) or other suitable structure of a material collection system 8, 30, 108, 118, 128. To facilitate coupling and decoupling of a removable head unit 140, suction hose 66 may couple to other parts of a conduit assembly 12 via a hose connector 69. Likewise, each of power line 44, input cooling fluid line 85, and return line 86 may include suitable connectors facilitating releasable coupling with the respective resources provided thereby. For example, in embodiments wherein the head unit 140 is used with material collection vehicle 30 power line 44 may receive power from a generator 46. Cooling fluid line 85 and return line 86 may be routed, respectively, from the chiller or returned to the chiller, as the case may be.

As an alternative to embodiments wherein the head unit 140 is formed as a distinct and separable part of a material collection system, the head unit 140 (or other head units described herein) may be provided differently. For example, in some embodiments, head unit 140 may be integrally formed as part of a collection conduit 112 or conduit assembly 12. Unless the context indicates otherwise, where reference is made in this disclosure to a head or head unit 140 (or other head unit described herein) of either of a collection conduit 112 or conduit assembly 12 it should be understood that the head unit 140 may be either fixedly connected to the structure to which it is coupled (e.g., a boom 18, 26 or mounting assembly 202) or releasably secured thereto. Where a head unit 140 is fixedly connected to a collection unit it may sometimes be referred to herein as the head portion of a collection conduit 112 or conduit assembly 12.

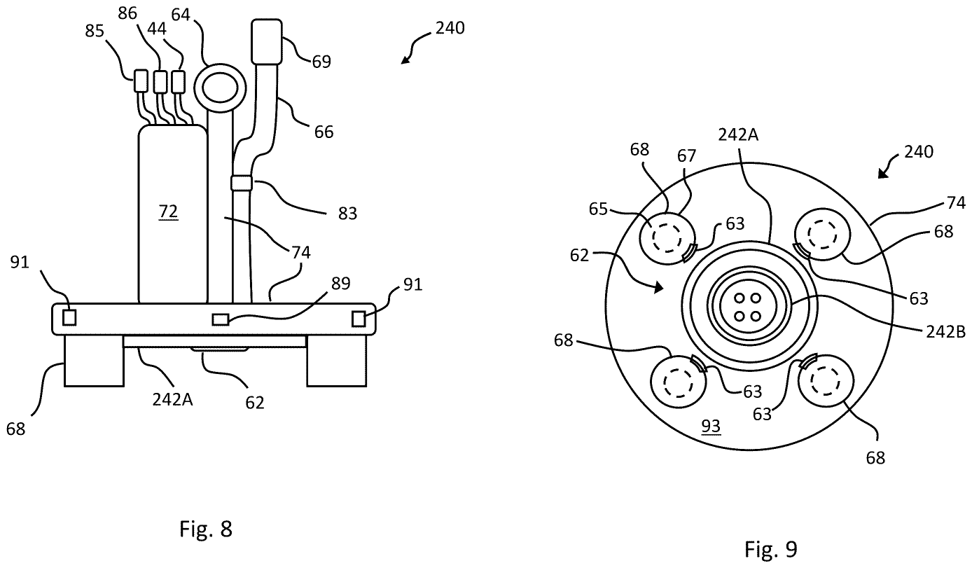

FIGS. 8 and 9 show another embodiment of a head unit 240. As shown therein, in some embodiments, the head unit 240 may include one or more projections or ribs 242A, 242B such as may extend from the outer surface 93 of the head unit 240. The one or more projections or ribs 242A, 242B may be made from or include a microwave absorbing material such as silicon carbide. In some embodiments, outer surface 93 may comprise a reflective surface so that microwave radiation incident thereon may be reflected for absorbance either by material adjacent thereto or by the one or more projections or ribs 242A, 242B. Generally, the projections or ribs 242A, 242B may provide a large surface area for absorbance of microwave radiation and resultant heating in the immediate vicinity of the suction inlet 62. Projection or ribs may fully encircle inlet 62 or may comprise an array that partially encircles inlet 62.

As shown in FIG. 9, an array of four magnetrons 68 may be disposed about the suction inlet 62. Other embodiments may include a different number of magnetrons 68 or some other number and type of microwave emitter may be provided. As further shown in FIG. 9, antenna 65 may be enclosed within a microwave reflective housing 67. One or more microwave apertures 63 or windows may be formed within the housing 67. For example, microwave apertures 63 may, for example, be comprised of quartz or some other suitable microwave transmitting or microwave transparent material may be used. Microwave apertures 63 may, for example, be used to direct emitted microwave radiation towards the one or more ribs 242A, 242B.

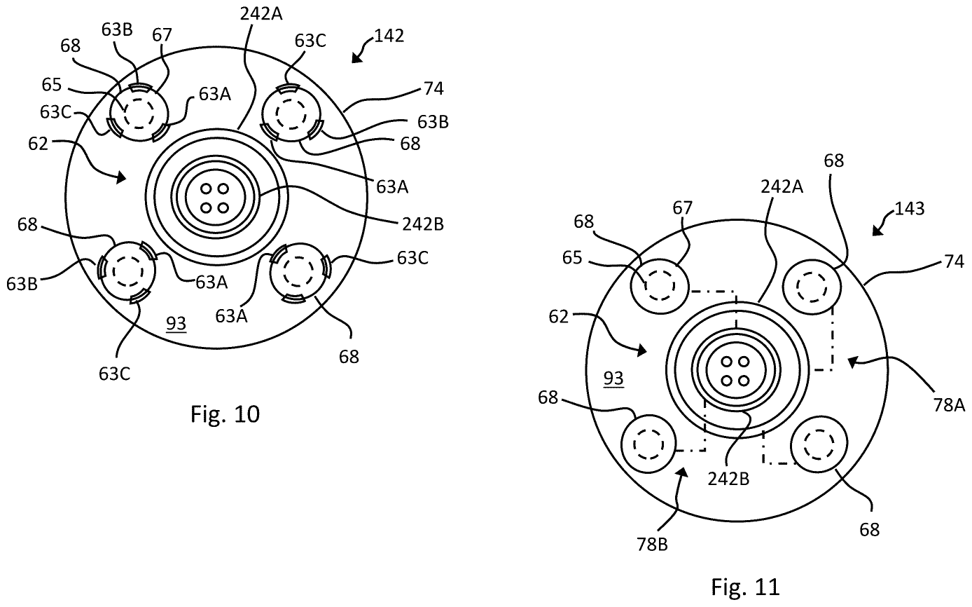

FIG. 10 and FIG. 11 are bottom plan views, respectively, of each of two related embodiments of head units 142, 143. FIG. 10 shows the head unit 142. As shown therein, the head unit 142 may include a plurality of adjustable microwave apertures 63A, 63B, 63C. In some embodiments, the apertures 63A, 63B, 63C may comprise windows that may be controlled so that emitted radiation may either be provided in a plurality of directions such as may irradiate a relatively large volume or hydrocarbon material about the head unit 142 or provided selectively towards the projections or ribs 242A, 242B. For example, if each of the windows or apertures 63A, 63B, 63C is maintained in an opened state a relatively large region or volume of hydrocarbon material about the head unit 142 will be irradiated. In an embodiment, apertures 63A, 63B, 63C may be provided with an adjustable shutter used for opening and closing the apertures 63A, 63B, 63C. In some embodiments, this may, for example, be used in an initial stage in establishing flow through a suction inlet 62 or when priming a pump. Alternatively, as may be used at other stages of collection (e.g., after establishing flow) only the windows 63A may be positioned to an opened state so that emitted energy may be directed preferentially towards one or more projections or ribs 242A, 242B.

As shown in FIG. 11 a head unit 143 may be provided with one or more waveguides 78A, 78B. For example, a first magnetron 68 may be coupled with a first waveguide 78A as may be disposed so as to route microwave radiation towards a first projection or rib 242A. A second waveguide 78B may be disposed so as to route microwave radiation towards a second projection or rib 242B. In some embodiments, routing of radiation may be controlled via a control system so that either or both of an outer projection or rib 242A and an inner projection or rib 242B may be heated or preferentially heated. Accordingly, the relative size of an irradiated or heated region or zone surrounding the suction inlet 62 may be controlled. In some embodiments, a relative size of a region or zone surrounding the suction inlet 62 may be controlled so as to optimize flow of hydrocarbon material or efficiency of collection.

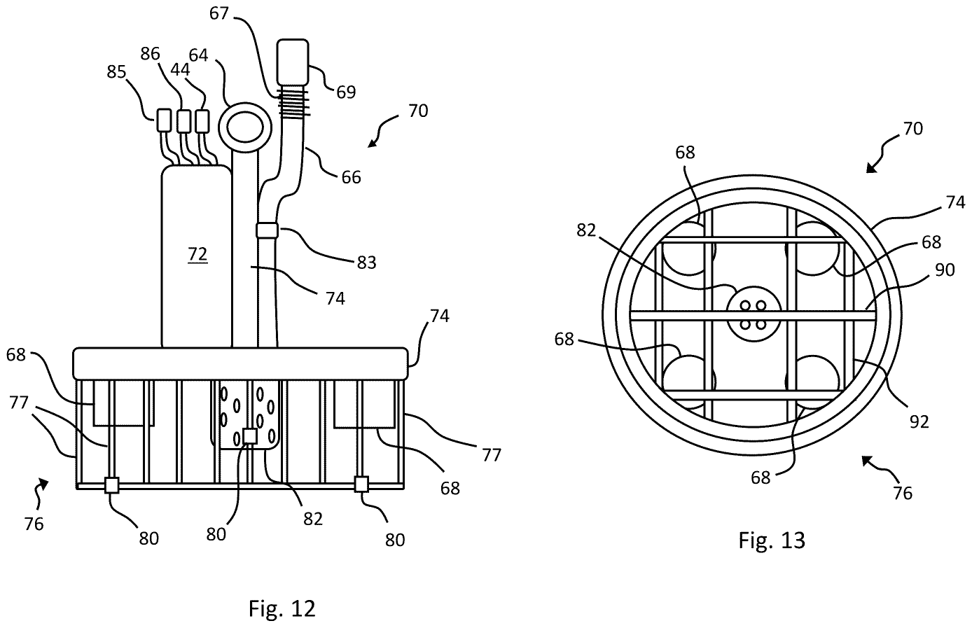

In some embodiments, given the heterogenous nature of some of the reservoirs described herein, it may be useful to provide a cage or cage-like structure surrounding an inlet of a collection conduit. For example, each of FIGS. 12-18 show a cage or cage-like structure 76 mounted to a collection unit 70, 100, 110, 120, 130 and surrounding an inlet of a collection conduit. This structure may generally act as a coarse filter, as may be used to filter out large debris. In some embodiments, other supporting structures around the suction inlet may also help to keep the inlet from becoming engaged with a submerged rock or log or other structure that may be found in a reservoir 16. In some embodiments, a cage or cage-like structure surrounding the inlet may play one or more additional roles in material collection beyond solely acting as a filter and may be sized, shaped, or materially composed accordingly. For example, in some embodiments, a cage or cage-like component may itself be heated such as may be facilitated by making the component from a microwave absorbing material such as silicon carbide, applying a coating of a microwave absorbing material, or otherwise configuring the component for absorbance of radiation. A heated cage may, for example, help a head unit 70, 100, 110, 120, 130 to move or cut through material of the reservoir 16 aiding in overall movement of the head unit 70, 100, 110, 120, 130 through viscous material in which it may be disposed.

In some embodiments, a cage surrounding an inlet may be configured so as to generally avoid impeding flow of hydrocarbon material through the cage. For example, as shown in FIG. 12 and FIG. 13, a cage 76 of head unit 70 may include a plurality of generally thin bars 77, 90, 92 such as may help the head unit 70 to move through or cut through a hydrocarbon material without generally disturbing the surrounding material or initiating flow or mixing of such material.

In some embodiments, however, a cage or cage-like structure may be configured differently. For example, a cage or cage-like structure may be shaped so that it may move through and encourage mixing of hydrocarbon material or movement of material towards a suction inlet. For example, a cage or cage-like structure may move through and direct material to move towards a suction inlet using shaped panels or walls thereby encouraging mixing and distribution of heat throughout a zone about the inlet. In some embodiments, a cage or cage-like structure may be shaped to encourage heating, mixing, or both of a hydrocarbon material. For example, as shown in FIG. 14 and FIG. 15, showing the head unit 100, panels or walls 96 may comprise a part of the cage 176. The panels or walls 96 may be extended in width so as to promote absorbance of radiation and concomitant heating thereof. Moreover, this increased surface area (above and beyond that provided by thin bars 77 of a cage 76, for example) provides an area of contact with hydrocarbon material so that conductive transfer of energy from the heated cage 176 to material in its vicinity may be encouraged. Accordingly, the panels or walls 96 may be both shaped and materially composed in a way that is useful for encouraging conductive heating of hydrocarbon material.

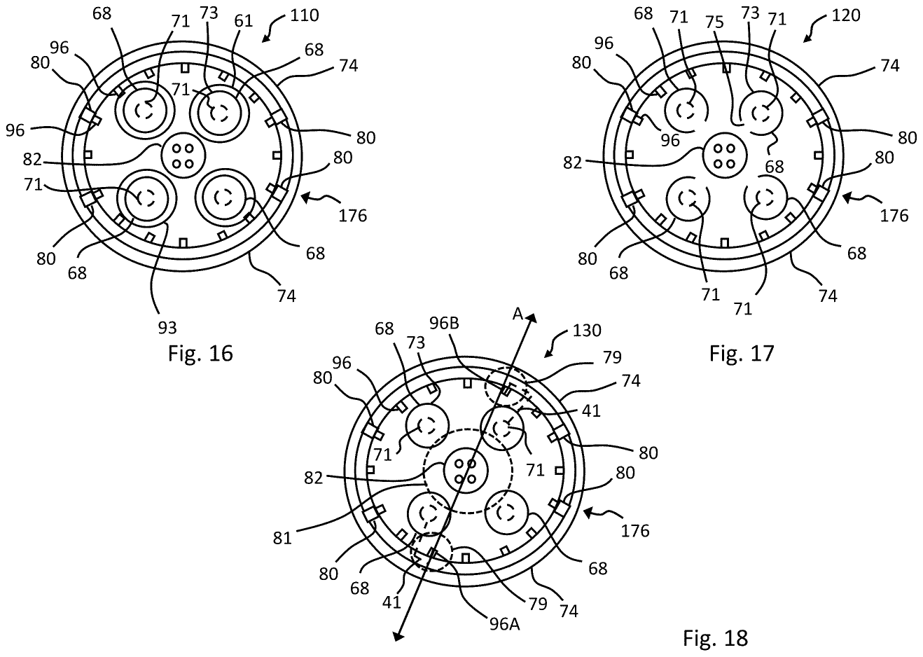

FIG. 16 shows a bottom plan view of another embodiment of a head unit 110. The head unit 110 includes an antenna 71 positioned within a housing 73 of radiation emitter 68. The housing 73 may, for example, allow for substantially uniform emission of radiation so that heating may be distributed over an area. In this embodiment, the various antenna 71 may be positioned in an array around the suction inlet 82 so that radiation intensity may, for example, be highest in a central zone surrounding the inlet 82. Power management resources 61 (e.g., a transformer and capacitor) may be coupled to the magnetron and used for control of power provided to the magnetron and subsequently its associated microwave emission.

FIG. 17 shows a bottom plan view of another embodiment of a head unit 120. As shown in FIG. 17, in some embodiments, a housing 73 may be generally opaque or reflective to microwave radiation. However, one or more radiation windows 75 may be positioned at selected locations to allow microwave radiation to pass therethrough allowing for selective irradiation of one or more regions about the radiation emitter 68. For example, in the illustrated embodiment shown in FIG. 17, windows 75 are generally directed centrally towards the inlet 82. In some embodiments, windows 75 may, for example, be made from a high density plastic such as may be allow for transmission of microwave radiation. Of course, the window 75 may be selected based on the particular radiation emitter 68 selected for use and vice versa.

FIG. 18 shows a bottom plan view of another embodiment of a head unit 130. As shown in FIG. 18, in some embodiments, a radiation emitter 68 may be coupled with a waveguide 41. Waveguide 41 may, for example, be used for routing microwave radiation to one or more panels or walls 96 making up the cage 176. Thus, one or more parts of a cage 176 may be heated by absorbance of microwave radiation. In some embodiments, a control system may be configured to control a part of a cage 176 that is heated. For example, only some of the panels or walls 96 of a cage 176 may be heated or configured to be heated. In some embodiments, a control system may further control movements, such as sweeping or rocking movements of a collection unit. For example, in some embodiments, a control system may control the heating of a cage, movements of a head unit, or both. Accordingly, the control system may rock or sweep a collection unit 130 generally in a direction A (generally extending in line with the heated panels 96A and 96B) so that the inlet is 82 is moved or rocked back and forth between peripheral heating zones 79 and a central heating zone 81 generally centered on a centered position of the suction inlet 82. In some embodiments, moving the suction inlet 82 in a direction towards the panels 96A, 96B may help to keep cooler material from moving towards the suction inlet 82 when the inlet is moved. Thus, for example, suction inlet 82 may continuously pump only heated hydrocarbon material thereby avoiding or reducing disruption of operation of pump machinery including when moving or sweeping the head unit in a given direction.

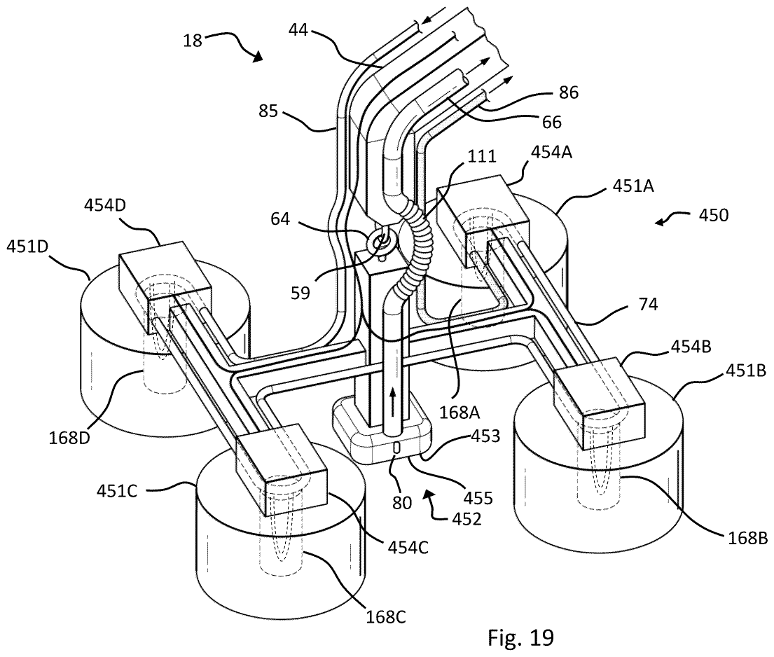

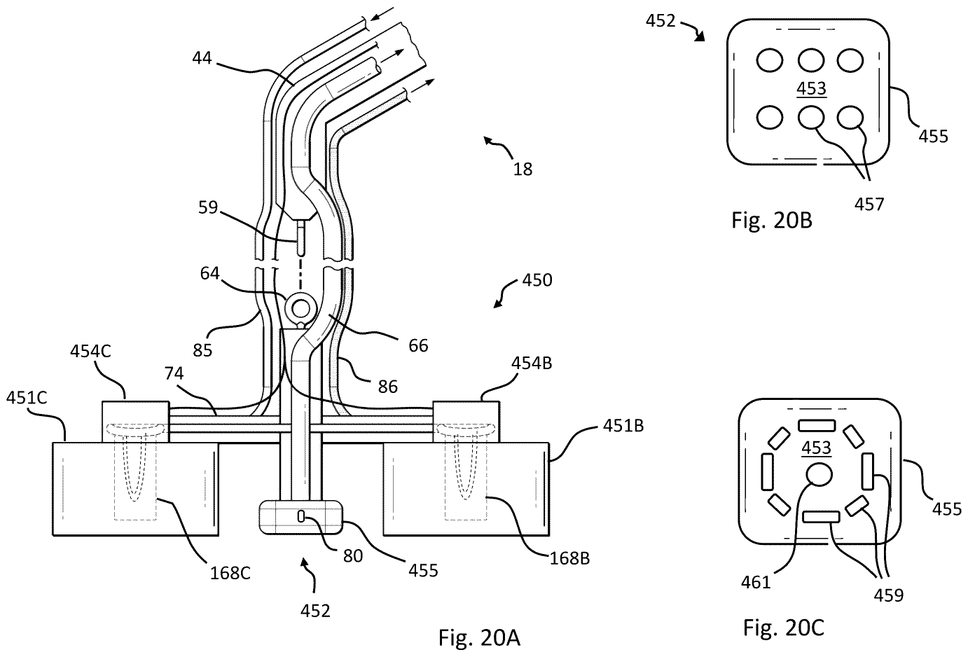

FIG. 19, FIG. 20A, and FIG. 20B show another embodiment of a head unit 450. As shown therein, the head unit 450 may include, among other components, a group of four microwave generators 168A, 168B, 168C, and 168D. The microwave generators 168A, 168B, 168C, and 168D may, for example, be embodied as magnetrons. However, in other embodiments, other suitable sources of microwave generation may be used. Microwave generators 168A, 168B, 168C, and 168D may be enclosed, respectively, in the housings 451A, 451B, 451C, 451D. In some embodiments, a given housing 451A, 451B, 451C, 451D may be comprised of a microwave transmitting material as may allow for substantially uniform irradiation of material in the vicinity of the head unit 450. In some embodiments, one or more microwave transmissive windows or apertures may be provided so that microwave radiation may be selectively emitted in a desired direction, such as toward a suction inlet 452.

Generally, the microwave generators 168A, 168B, 168C, and 168D may be configured as necessary to provide required microwave radiation as suitable to achieve a level of heating at least in a central zone or region nearby the suction inlet 452. For example, in some embodiments, heating in a central zone or region about the suction inlet 452 may be sufficient to heat hydrocarbon material to a temperature between about 280° F. to about 400° F. In some embodiments, a localized temperature of material in the vicinity of the suction inlet 452 may be between about 300° F. to about 350° F. One or more temperature sensors 80 may be disposed so as to measure a localized temperature at or near the suction inlet 452. A material collection control system may, for example, comprise one or more sensors 80 providing a feedback signal used for controlling characteristics of material collection, including, but not limited to a power, intensity, frequency, and/or other characteristics of radiation used for heating of hydrocarbon material. In some embodiments, a temperature in the vicinity of a suction inlet may be maintained at less than about 420° F., less than about 400° F., less than about 375° F., or less than about 350° F. Generally, temperatures used for collection of asphalt or tar in the systems herein may be significantly lower than those generally used in other hydrocarbon collection systems including those used for collecting shale oil from subsurface geologic formations.

In some embodiments, temperature sensors 80 may be placed at other positions along the head unit 450. For example, additional sensors may be positioned at different positions along a housing of the head unit 450. A distribution of sensors may, for example, be used to better characterize a temperature profile at the suction inlet and at other positions near the inlet. In some embodiments, a temperature gradient may be used to control one or more system components. For example, a control system may calculate a temperature gradient between one or more parts of the housing and the inlet 452 and adjust system components (e.g., pump components and heating components or microwave generators 168A, 168B, 168C, and 168D) based on the calculated temperature gradient. In some embodiments, a temperature gradient may be used to estimate a size of a heated zone about a suction inlet. For example, a size of a heated zone may be generally defined as a volume of material encompassing a certain temperature boundary.

In some embodiments, a flow rate sensor may be used to calculate a flow rate through the suction hose 66. A material collection control system may, for example, comprise one or more flow rate sensors 83 and adjust system components (e.g., pump components and heating components or microwave generators 168A, 168B, 168C, and 168D) based on a calculated flow rate.

Microwave generators 168A, 168B, 168C, and 168D may be suitably configured as may be needed for providing heat suitable for achieving the above temperatures or other suitable temperatures in the vicinity of a suction inlet 452. For example, in some embodiments, microwave generators 168A, 168B, 168C, and 168D may be configured for providing between about 250 kW to about 550 kW of power for heating material generally located in a zone around the suction inlet 452. For example, four generators each operating at about 60 kW to about 140 kW may be used. In another example, four generators may each operate at about 75 kW. Notably, however, some embodiments described herein may be particularly configured to allow for sustained heating of material in the proximity of a suction inlet using reduced power than other embodiments. Accordingly, some embodiments herein may, generally, be configured with appropriate “minimum power requirements” that may be reduced as compared to other embodiments. Generally, any suitable microwave frequency of radiation may be used for heating hydrocarbon material. For example, in some embodiments, 2.45 GHz microwave radiation may be used for heating hydrocarbon material. In some embodiments, power used by the microwave generators 168A, 168B, 168C, and 168D may be provided from a separate power resource (e.g., using generator 46 of material collection vehicle 30) as may be supplied using power line 44. As shown in FIG. 19 and FIG. 20, power line 44 may, for example, be run to each of four different power control units 454A, 454B, 454C, 454D such as may include necessary components (e.g., capacitors and transformers) suitable for conditioning received electrical energy for use by the given microwave generator 168A, 168B, 168C, 168D.

FIG. 20B shows a bottom plan view of the inlet 452. As shown therein, in some embodiments, a bottom surface 453 of the inlet 452 may comprise a plurality of inlet openings 457 through which hydrocarbon material may be collected. Openings 457 may communicate collected material through to the suction hose 66 through an inlet housing or body 455. Generally, inlet housing or body 455 may be comprised of any suitable material (e.g., a suitably durable material) for withstanding the environment in which it is disposed. In some embodiments, the inlet housing or body 455 may be comprised of a microwave absorbing material such as silicon carbide. Microwave radiation may be absorbed by the housing or body 455 so as to heat the body. A surrounding region of material nearby the suction inlet 452 may then be heated through conduction of energy from the housing or body 455. In some embodiments, any combination of an antenna, waveguide, or other microwave optics (e.g., window or shutters) may be used to direct microwave radiation or direct radiation towards the suction inlet 452. Generally, as illustrated in FIG. 19 and FIGS. 20A-20C, the housing 455 is provided about inlet openings 457, 461. However, in some embodiments, a housing 455 forming the inlet may also house other components of the head unit 450. For example, inlet openings 457, 461 (shown respectively, in FIG. 20B and FIG. 20C) may be formed in an overall housing for the head unit 450. In some such embodiments, the entire housing may be made from silicon carbide or otherwise include silicon carbide. For example, silicon carbide may be added as a coating or layer of the housing. In some embodiments, silicon carbide (or another microwave absorbing material) may be including in a housing for a head unit 450 but only a selected portion of the housing (e.g., a portion of the housing formed about the inlet 461 may include a microwave absorbing material.

FIG. 20C shows another embodiment of a housing 455 for an inlet. As shown therein, an inlet 452 may include an inlet opening 461 as may include projections 459 disposed about the inlet opening 461. Projections 459 may, for example, be made of silicon carbide (e.g., the projections may be fully made from silicon carbide or the projections may be coated with silicon carbide). Projections 459 may provide for absorbance around the inlet opening. In some embodiments, as opposed to projections 459 a housing 455 or surface 453 thereof may be formed with grooves or other surface structure as may, for example, provide surface area about an inlet opening 461 facilitating effective absorbance of microwave radiation and conductive heating of hydrocarbon material in the vicinity of he inlet opening 461.

As further shown in FIG. 19 and FIG. 20A, head unit 450 may further include input fluid line 85 and return fluid line 86 as may be used for circulating a coolant fluid about the microwave generators 168A, 168B, 168C, 168D and associated power distribution resources 454A, 454B, 454C, 454D. Suction hose 66 may, for example, comprise an intake portion of either of collection conduit 112 or conduit assembly 12 (as the case may be for different embodiments) and may be configured for routing collected hydrocarbon material from suction inlet 452 through the head unit 450 and to the supporting structure about which the head unit 450 is secured. For example, in the illustrated embodiment, suction hose 66 may route collected hydrocarbon material through the boom 18. At least a part of the suction hose 66 may be flexibly extendable as may accommodate for relative movements of the head unit 450. For example, as shown in FIG. 19, in some embodiments, a portion of suction hose 66 may comprise a bellows tubing 111.

Head unit 450 may further include a connector 64 such as is embodied in FIG. 19 and FIG. 20 as a ring eyelet. A hook 59 may engage with the connector 64 when securing head unit 450 to the boom 18, for example. Alternatively, hook 59 may be part of the boom 26 or of the mounting assembly 202, for example. Connector 64 may be secured to a frame 74. The frame 74 may generally be configured with suitable strength and durability for movement within the reservoir 16.

As described herein, in some embodiments, a head unit 14 (or other head unit as described herein) may be heated. In some embodiments, the head unit 14 may also be moved, including while collecting hydrocarbon material or at least when mapping out a local volume of space within a reservoir 16 as may be used to establish an optimum position in the reservoir for material collection. Such operations may, for example, be executed to improve the efficiency for collection of hydrocarbon material or to map a hydrocarbon reservoir so as to identify areas of the reservoir most suited for efficient collection. In some embodiments, the execution of such operations and/or other operations as described herein may be controlled through a control system.

Notably, when moving through a reservoir including a highly viscous composition it may be important to keep heated material in the vicinity of an inlet. For example, if a suction inlet is moved too quickly heated material in the vicinity of the inlet may be displaced by cooler material. This may, for example, lead to disruption of pump pressure and demand repriming of the system thereby slowing down system operation. In some cases, an unexpected decrease in the local viscosity around a suction inlet may also risk damaging system pump machinery.

Generally, the risk of displacement of heated material with cooler material may be more significant when a relatively concentrated zone of heating is provided about a suction inlet. However, some embodiments that may operate with high efficiency may generally benefit from maintaining a relatively small zone of heating about a suction inlet as this may generally limit expenditure of unnecessary energy heating material far from the inlet. The particular boundaries defining the volume of a heated zone about a suction inlet that may lead to optimal system efficiency may be complicated and may depend on the particular composition and viscosity or local changes in viscosity about the inlet.

In light of at least the above considerations, some embodiments herein may be directed to providing systems wherein a zone of heating about an inlet may be expanded or decreased. For example, different protocols for heating may be executed as may generally provide different zones of heating and the relative flow rates of material may be established. Generally, this may allow systems herein to improve a collection efficiency for hydrocarbon material.

In some embodiments, methods of moving a head unit may provide for heating of material in one or more zones outside of a central zone about a suction inlet. Such heating or “preheating” of material may be controlled by a control system and may, for example, enable movement of a head unit without having to reprime a system for pumping and without risking disruption of pump machinery.

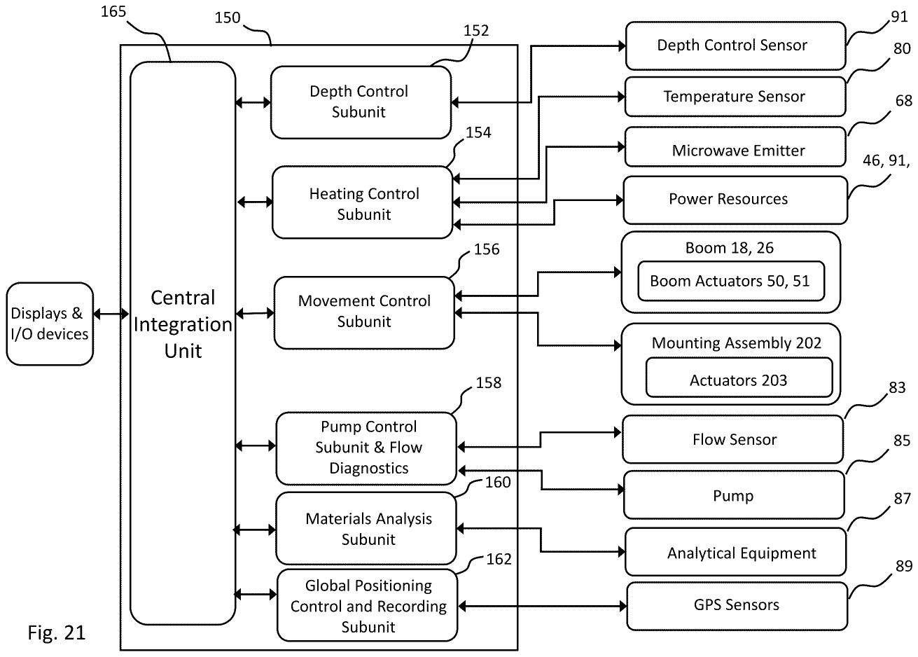

FIG. 21 shows an embodiment of a control system as may be used, for example, when executing one or more methods involving the movement or heating of a head unit. Generally, the control system 150 may be configured for controlling execution of various operations including, by way of nonlimiting example, selection or adjustment of the depth of a collection unit, control of microwave emission and/or the direction of emitted radiation, movement of a collection unit or conduit head, control of requisite pump and pump machinery, analysis of analytical or sensor data, recording of data (e.g., collection data for the position of a conduit head over time and associated collection efficiency as a function of position), and other operations as may be executed in the systems and methods described herein. In some embodiments, control system 150 may comprise computing resources (e.g., one or more computers) such as may be integrated within one or more machines or vehicles of a system for hydrocarbon material collection.

In some embodiments, the control system 150 may comprise a standalone computer that may be in communication with at least one material collection vehicles such as at least one of material collection vehicles 10, 30. For example, a control system 150 may be configured to control the operation of a single material collection vehicle. However, in some embodiments, it may be advantageous for a control system 150 to organize the work of a plurality of material collection machines or vehicles. For example, in some embodiments, data for the efficiency of material collection at different positions within a reservoir (e.g., global position data for a collection unit or conduit head and related flow data) may be collected for various different collection conduits such as may be mounted to a plurality of different machines or vehicles of a system for hydrocarbon material collection. Such information may, for example, be collected and analyzed together so as to help map a given reservoir 16 and to guide positioning of different collection units so as to generally optimize efficiency of hydrocarbon material collection.

As shown in FIG. 21, in some embodiments, a control system 150 may include a central integration unit 165. Central integration unit 165 may generally include computing resources used to analyze different data streams coming from different subunits and provide commands for controlling the different subunits and the various system components in communication therewith. Of course, the control system 150 may be provided with one or more display screens and requisite input/output (I/O) devices as may be useful for communication of data and for receiving input (e.g., control of system settings) from an operator. In some embodiments, such display screens may be provided in a cab 32 of a machine collection vehicle 10, 30, for example. In some embodiments, data collected using a control system 150 may be sent to different devices. For example, data useful for controlling an individual crawler crane 10, 30 or other material collection vehicle may be provided to a display screen included in the cab 32. Other data, including, for example, data associated with the performance of different material collection vehicles or different regions of a reservoir 16 may be sent to a different device. Such as a handheld device (e.g., an iPad device) including a suitably programmed application and used by a foreman or manager, for example. Such data may also be sent offsite to a remote facility for interpretation and analysis. In some embodiments, this data may be used to control one or more autonomous material collection machines or vehicles.

Generally, the various system components shown in FIG. 21 and other system components described herein may communicate with the control system 150 via any suitable means. For example, in some embodiments, sensors and other system components (e.g., actuators as may be used for controlling or positioning a boom 18, 26, mounting assembly 202, or mounting arm 200) may be in communication with the control system 150 via wired or wireless means.

In some embodiments, a material collection system may include a control system 150 suitable for recording the position of a head unit 14 or other head unit versus time. This may, for example, be used together with data collected for collection of hydrocarbon material to map the relative efficiency of material collection at different positions in the reservoir 16. For example, a flow sensor 83 (see FIG. 6, for example) may be used to collect flow rate data versus time for a given head unit such as head unit 14. Other sensor data may likewise be recorded so that the various data streams may be recorded. For example, as shown in FIG. 21, a global positioning control and recording subunit 162 may receive data from one or more global positioning system (GPS) sensors 89. To record material collection efficiency one or more flow sensors 83 may be used. However, flow data may be considered along with other material collection data, such as may also be collected using sensors positioned within the storage units or tanks 29, 42, as described herein. For example, analytical data may be collected using analytical equipment 87 as may perform chemical analyses on collected material. For example, analytical equipment 87 may comprise a spectrometer as may identify whether given samples of material may be more or less useful as a product. In one example, analytical equipment may be configured to characterize a proportion of different chain length hydrocarbons present in a hydrocarbon composition as may generally correlate to different valued collected compositions.

The control system 150 may include either or both a depth-control subunit 152 and a movement control subunit 156. These two subunits 152, 156 may, for example, work together so as to generally position a head unit 14 (or head unit described herein) of a conduit within the reservoir 16. In one example, depth control subunit 152 may send signals and/or receive data from depth control sensor 91 (see FIGS. 6 & 8, for example). Depth control sensor 91 may, for example, be an ultrasound sensor and may be configured for sending and receiving ultrasound pulses for establishing the depth of a collection unit or head of a collection conduit. Movement control subunit 156 may send signals and/or receive data from the various positioning resources available to a collection system. For example, movement control subunit 156 may generally be in communication with any of the actuators used in positioning any of the booms 18, 26, mounting arm 200, or mounting assembly 202. Other subunit systems may include, heating control subunit 154, pump control system and diagnostics subunit 158 and materials analysis subunit 160.

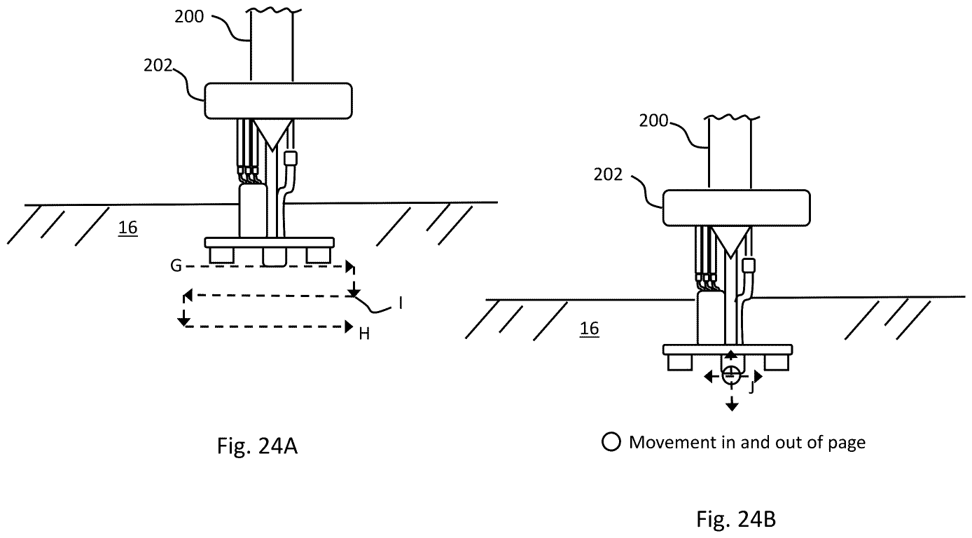

For example, as shown in FIGS. 22A and 22B, a head unit 60 may be moved laterally through a reservoir 16 via adjustment of one or more actuators 203 provided in the mounting assembly 202. For example, actuators 203 may adjust the position of a mounting plate 205 so as to move the plate laterally as shown in FIG. 22A. Mounting plate 205 may, for example, be disposed on a rail system 211 supporting movement of the plate 205 in one or more directions. A connecting mount 204 may be secured to the plate 205 so that the head unit 60 (secured to the mount assembly 202 through the mount 204) may be controlled using the actuator 203. An additional actuator 203 (not shown in FIG. 22A) may control corresponding movements in and out of the plane of the page. (see FIG. 24B). Of course, other systems may be used for movement of a mounting plate 205. Alternatively, in some embodiments or for other lateral movements, the head unit 60 may be moved using one or more boom actuators 50, 51 provided for initiating movement of a boom 18, 26. For example, as shown in FIG. 22A, head unit 60 (and its associated inlet 62) may be moved laterally, along the line of movement D from a first position B to a second position C. The position of the head unit 60 in each of the two positions B, C may be determined using GPS sensor 89, for example. In some embodiments, the head unit 60 may be stepped between the two positions B, C and held in each position so that material collection data may be obtained in each of the two positions B, C, including at one or more heating, temperature, and/or pump conditions. For example, the head unit 60 may be moved to the position C and flow data may be collected for a first set of heating conditions, temperature conditions, or pump conditions. It may be useful for flow data (or another suitable surrogate measure of a rate of material collection) to be obtained for a first set of heating conditions (or other conditions) and with the head unit 60 held in place for a necessary period of time so that a zone of heating 81 substantially reaches equilibrium about the inlet 62. In some embodiments, flow data may be collected with the head unit 60 held at the position C and for a plurality of different heating conditions (or for other conditions). The necessary data (e.g., flow data, temperature data, power consumption data, and position data) may generally be sent to central integration unit 165 so that one or metrics of material collection, including, for example, rate of material collection, rate of power consumption, or efficiency of material consumption may be determined. For example, in this context, an amount or volume of hydrocarbon material per unit of time may be ratioed against energy consumed for the same period of time so as to provide a metric of collection efficiency.

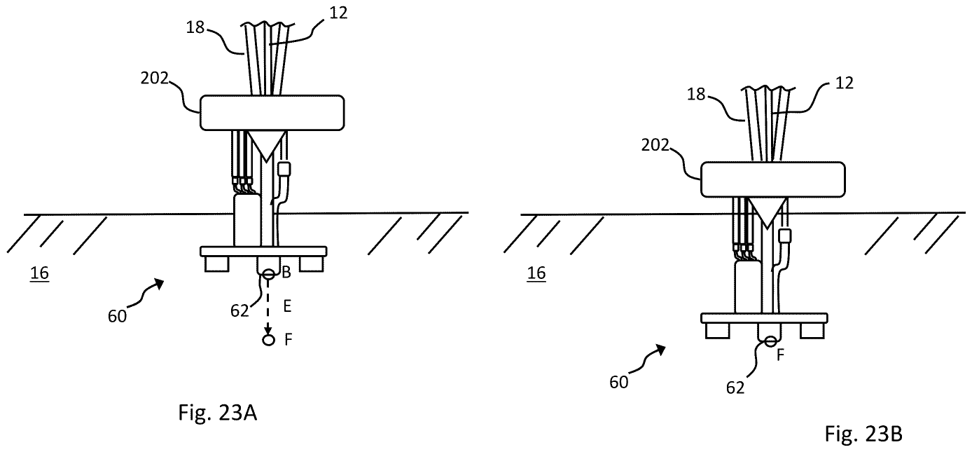

As shown in FIG. 23A and FIG. 23B, a head unit 60 may also be moved vertically through a reservoir 16. For example, in some embodiments, vertical adjustment of the position of the head unit 60 may be accomplished using a boom 18, 26. Alternatively, for example, vertical adjustment of the position of the head unit 60 may be accomplished using a mounting arm 200 or using other suitable means. For example, as shown in FIG. 23A and FIG. 23B, a head unit 60 may be moved vertically along the line E from a first position B (shown in FIG. 23A) to a second position F (shown in FIG. 23B). As similarly described above, flow or other data may be collected with the head unit 60 held at the position F and for one or more different heating or other conditions. Necessary data (e.g., flow data, temperature data, power consumption data, and position data) may be sent to central integration unit 165 so that one or metrics of material collection, including, for example, rate of material collection, rate of power consumption, or efficiency of material consumption may be determined.

In some embodiments, as shown in FIG. 24A, a head unit 60 may be moved in a plurality of different directions through a reservoir 16. For example, the head unit 60 may move along the pathway between a first position G and a second position H. At each of various intermediate positions along the pathway from position G to position H (e.g., at intermediate position I) flow or other data may be collected including, for example, at one or more different heating or other conditions. Of course, other movements (e.g., movements in and out of the plane displayed for FIG. 24B) may also be executed. Thus, for example, a head unit 60 may be moved across a given volume of a reservoir 16 and collection efficiency or other metrics may be determined.

In some embodiments, movements as shown in FIG. 22-24, for example, may be executed automatically during a routine for probing a given region or volume of space within a reservoir 16 and obtaining material collection data. Using data collected in such a routine, one or more performance metrics may be determined. Based on one or more of such metrics, a head unit 60 (or other collection unit as described herein) may be fixed at a given location and continue to collect material at least until triggered otherwise. For example, as long as material is collected at an acceptable level (e.g., above a threshold rate of material collection) the head unit 60 may remain fixed in place.

### METHODS INVOLVING THE SYSTEMS AND COMPONENTS DESCRIBED HEREIN

Generally, the systems and related components (e.g., head units and control systems) described herein may be used in performing methods for collecting hydrocarbon compositions or for executing other related methods, including, for example, methods for mapping a hydrocarbon reservoir or for positioning a head unit of a material collection conduit.

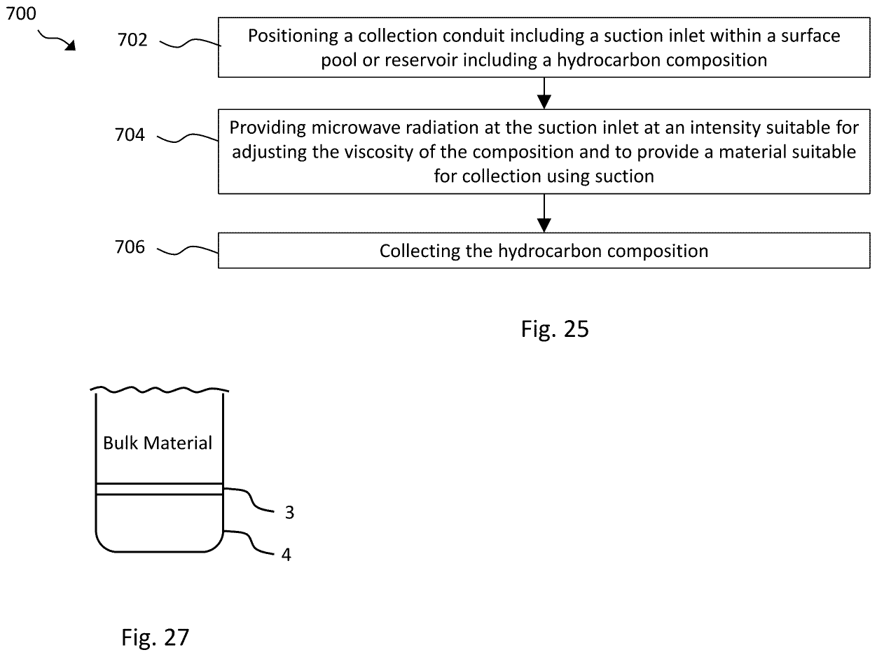

An embodiment of a method 700 for collecting a hydrocarbon composition is shown in FIG. 25. As shown therein, at step 702, a collection conduit including a suction inlet may be positioned within a surface pool or reservoir including a hydrocarbon composition. The surface pool or reservoir may, for example, comprise a hydrocarbon composition including, for example, asphalt, tar, pitch, or another highly viscous hydrocarbon compositions. Such reservoirs may also be described as semi-solid compositions or other liquid-solid hybrid compositions. The collection conduit may, for example, include a head unit 14 (or other head unit as described herein) including at least one microwave emitting resource. In one example, as shown in FIG. 19 & FIG. 20, the head unit may include a group of four magnetrons positioned in an array about the suction inlet.

As shown at step 704, microwave radiation may be provided at the suction inlet so as to decrease the viscosity of the composition. For example, microwave radiation may be supplied at or near the suction inlet so as to adjust the viscosity of the composition and to provide a material suitable for collection using suction. In some embodiments, a head unit positioned in the composition may be made from a microwave absorbing material such as silicon carbide. For example, the suction inlet or an outer surface of the head unit may include a silicon carbide coating. At step 706, the hydrocarbon composition may be collected.

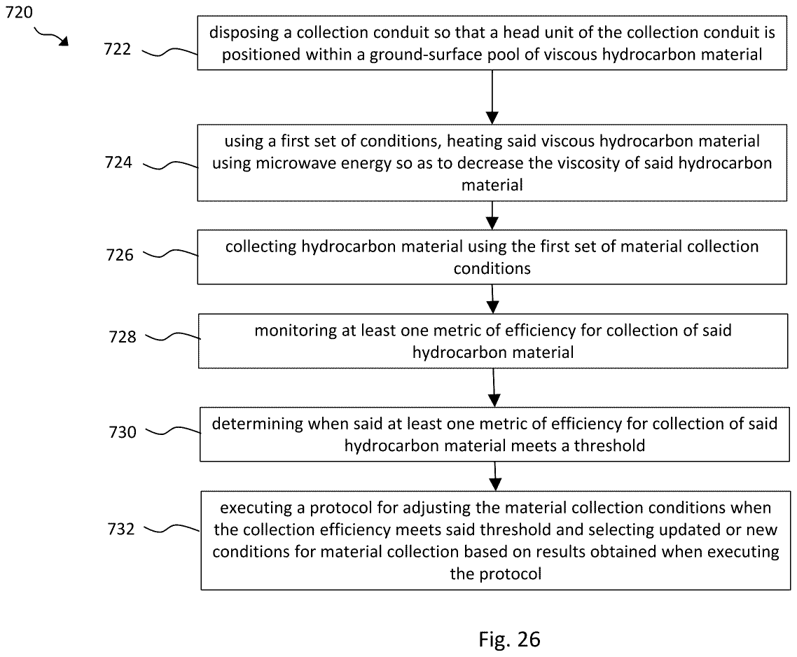

An embodiment of a method 720 for controlling operation of a hydrocarbon collection system is shown in FIG. 26. As shown therein, at step 722, a collection conduit may be disposed so that a head unit of the collection conduit is positioned under the surface of a ground-surface pool of viscous hydrocarbon material. At step 724, the viscous hydrocarbon material may be heated using microwave energy so as to decrease the viscosity of said hydrocarbon material. In some embodiments, heating of hydrocarbon material may be executed under one or more conditions or parameters for collection of the hydrocarbon material so that a best set of conditions may be established. Alternatively, a first set of conditions may be established empirically or in some other way.

For example, in some embodiments, a set of conditions for collection may include any of various controllable settings for material collection as described in this disclosure. For example, a set of conditions for collection of material may including power resources supplied to a head unit and pump conditions for material collection. As another example, any parameter or condition measured using the sensos herein may also be used to establish a set of conditions for material collection. To provide an example, temperature (as may be measured using one or more temperature sensors 80) or head unit depth (as may be measured using depth control sensor 91) may be set as a condition for material collection. A position (e.g., GPS coordinates for head unit position) at which a head unit is held in place or about which a head unit is swept may also be a parameter or condition for material collection. In some embodiments, settings for a head unit (e.g., one or more positions for adjustable apertures or shutters or other settings that may influence how a zone of heating is created or sized around a head unit) may also be defined. In some embodiments, procedures for sweeping a head unit (e.g., sweeping speed or trajectories) may also be defined. Other parameters or settings may be selected when defining a set of conditions for material collection. Generally, in some embodiments, any of those parameters or settings may be changed (see step 730) in embodiments herein.

As shown at step 726, hydrocarbon material may be collected using the first set of conditions. And, as shown at step 728, a metric associated with the collection efficiency may be determined. For example, a control system may receive data corresponding to operation of power resource for the system. The control system may further receive flow data as may be provided, for example, using the flow sensor 83. In some embodiments, analytical equipment 87 may perform chemical analyses on collected material so that at least an initial estimate of quality or value of the collected product may be determined. Generally, efficiency of collection may reflect an energy used for collecting a given product or product of given quality. A control system may monitor the efficiency of material collection by collecting data for a given metric of efficiency over time.

As shown at step 730, a control system 150 may automatically flag when a given metric of efficiency changes so as to cross a certain threshold. For example, a threshold level of efficiency may be selected based on a percentage or ratio decrease in collection efficiency versus an initial value. Alternatively, another threshold level of efficiency may be set or selected. As shown at step 732, a protocol may be executed for testing new conditions for material collection. Results obtained when executing the protocol may then be used for selecting a new set of conditions for material collection.

In some embodiments, any of the various conditions as applied in step 724 may be changed when executing a protocol for testing of new conditions. By way of example, execution of a protocol for adjusting the conditions for material collection may involve moving the head unit to a new position within the reservoir. For example, in some embodiments, an operator of a material collection vehicle may receive a signal that the collection efficiency has decreased or otherwise that a threshold condition has been met. Instructions to move a head unit or for changing other conditions of material collection may also be sent to the operator. For exmaple, instructions to move the head unit may be received by an operator together with designation of GPS or other coordinate data for positioning the head unit. This coordinate data, may, for example, be provided to the operator by a foreman or manager provided with data mapping the collection efficiency found for different head units positioned across different regions of the reservoir. Additional data may also be provided from aerial drone 53, for example.

In some embodiments, adjusting conditions for material collection may include automatically sweeping or moving the head unit over some region or zone. For example, as shown in each of FIGS. 22-24, in some embodiments, a head unit may be configured so that it may be moved or swept over a given region or zone. Although shown by example in FIGS. 22-24 as scanning of a head unit attached to a mounting assembly, in other embodiments, scanning may involve controlling a boom 18, 26 so that associated movements may take place. For example, in some embodiments, a control system 150 may operatively engage with boom actuators 50, 51 such that the position of a head unit may be controlled accordingly. Relevant sensor data (e.g., GPS sensor data 89 and depth control sensor 91 may be collected when a control system 150 takes operation of the boom actuators 50, 51 when executing a protocol for sweeping or scanning a head unit over a given region of a reservoir.

Importantly, in some embodiments, a head unit may be moved or swept to different points without the head unit being moved above the surface of the reservoir. For example, as shown in FIGS. 24A and 24B, a head unit may be moved in a three dimensional pattern around an initial position. Relevant data (e.g., flow rates for material collection or other data to determine a collection efficiency or quality of material collected) may be obtained at different points along the path of movement. In some embodiments, data may be collected by moving to given position (e.g., a given position within a region or volume being tested) and allowing for the head unit to remain in place until relevant data is collected. For example, the head unit may be moved to a new position and held in place until a flow rate normalizes or approaches an equilibrium position. However, in some embodiments, a head unit may be scanned over a region and flow rate data may be continuously collected. A speed at which a head unit moves may be controlled as may be suitable for a given protocol (e.g., one where movement is continuous or not) so that appropriate data is collected.

In some embodiments, a head unit may be moved over a region or zone within a reservoir in a way that minimizes a risk that cooler material may displace heated material at the inlet. This may, for example, be used so as to minimize risk of interruption of flow of material to pump machinery. Accordingly, for example, a region may be scanned without having to reprime a pump. For example, in some embodiments, a priming fluid may sometimes be injected around the inlet so that pump machinery may initially engage with a more fluid material. As material becomes distributed throughout a collection conduit priming fluid may be tapered off or stopped. This may, for example, be achieved once suitable heating takes place at the suction inlet so that suitable changes in viscosity occur so as to transform an otherwise unpumpable or difficult to pump composition into one pumpable using the available or set pump conditions. If the viscosity in the vicinity of the inlet unexpectedly rises disruption of pumping may sometimes occur.

In some embodiments, a protocol for movement of a head unit to minimize risk of flow disruption during scanning may include increasing a level of heating (e.g., increasing power consumption), heating of a larger zone or volume of material while a head unit is swept, or both. For example, in some embodiments, as shown in FIG. 11 a head unit 143 may be configured so that microwave energy may be selectively provided in different ways, including, for example, providing microwave energy to either of one group of projections or ribs 242A or another group or projection of ribs 242B. This may be executed, so that a relative size of a heated zone about an inlet may be controlled. Thus, for example, when moving a head unit, a larger heated zone may generally be formed about the suction inlet.

In another example, a protocol for movement of a head unit to minimize risk of flow disruption during scanning may include heating a cage or cage-like component about a suction inlet. For example, as shown in FIG. 18, a waveguide 41 may, for example, be used for routing microwave radiation to one or more panels or walls 96 making up the cage 176. Alternatively, adjustable apertures 63A, 63B, 63C may be controlled (as shown in FIG. 10) so as to increase a zone of heating about an inlet or to selectively heat a cage or one or more parts of a cage. In another example, a protocol for movement of a head unit may include selectively heating a given area of a cage. For example, a suction inlet may be swept over a preheated zone of material. For example, as shown in FIG. 18, an inlet 82 may be swept along the line A so that the inlet is moved over a preheated zone of material 79 when scanning a head unit.

Thus, in this disclosure, any of a number of different protocols are described so as to improve the efficiency for sweeping a head unit over a given zone as may be used to help identify an optimal position for a head unit for collecting hydrocarbon material. Although sweeping or movement of a head unit is generally described above as used in a method for helping to map a given zone or region of a reservoir or to help select a set of conditions for material collection, some embodiments herein may move sweep or rock a head unit as part of a normal protocol for material collection. For example, in some embodiments, a head unit 130 may be swept or rocked about the line A so as to improve material collection.

Although the foregoing specific details describe certain embodiments of this invention, persons of ordinary skill in the art will recognize that various changes may be made in the details of this invention without departing from the spirit and scope of the invention as defined in the appended claims and other claims that may be drawn to this invention and considering the doctrine of equivalents. Among other things, any feature described for one embodiment may be used in any other embodiment, and any feature described herein may be used independently or in combination with other features. Also, unless the context indicates otherwise, it should be understood that when a component is described herein as being mounted or connected to another component, such mounting or connection may be direct with no intermediate components or indirect with one or more intermediate components. Therefore, it should be understood that this invention is not to be limited to the specific details shown and described herein.

What is claimed is:

1. A machine comprising:
a vehicle including a boom having a first end and a second end, the boom being coupled to the vehicle at the first end; and
a collection conduit including a head unit, the head unit being coupled to the second end of the boom, the head unit comprising:
an intake portion of the collection conduit including an inlet;
a source of microwave radiation disposed to provide microwave radiation for heating material in a zone about the inlet when the head unit is positioned within a reservoir including a hydrocarbon composition.

2. The machine of claim 1 wherein the boom is telescopically extendable and retractable, the boom including at least two boom sections configured for nested engagement therebetween, the collection conduit being flexibly extendable so as to extend or retract with the boom.

3. (canceled)

4. The machine of claim 1 wherein the collection conduit extends from the head unit through at least a portion of the boom.

5. The machine of claim 1 further comprising a spool configured for feeding said collection conduit through said boom during extension of the boom.

6. The machine of claim 1 wherein the vehicle is a crawler crane.

7. (canceled)

8. The machine of claim 1 wherein the head unit comprises a housing forming said inlet, the housing being made of a microwave absorbing material and configured for heating through absorbance of microwave radiation provided from the source of microwave radiation.

9. The machine of claim 8 wherein the housing forming said inlet is made of silicon carbide.

10-14. (canceled)

15. The machine of claim 1 wherein the source of microwave radiation includes a plurality of magnetrons mounted to a head unit frame, the plurality of magnetrons being positioned about said inlet.

16. The machine of claim 15 wherein each magnetron among the plurality of magnetrons includes a waveguide or antenna oriented to direct microwave energy toward a zone about the inlet.

17-22. (canceled)

23. A system for collecting a hydrocarbon composition comprising:
a boom having a first end and a second end; and
a collection conduit including a head unit, the head unit being coupled to the second end of the boom, the head unit comprising:
an intake portion of the collection conduit including an inlet;
a source microwave radiation disposed at a position for providing microwave radiation for heating material in a zone about the inlet when the inlet is positioned within a reservoir including said hydrocarbon composition.

24. The system of claim 23 wherein the boom is telescopically extendable and retractable, the boom including at least two boom sections configured for nested engagement therebetween, the collection conduit being flexibly extendable so as to extend or retract with the boom.

25. (canceled)

26. (canceled)

27. The system of claim 23 wherein the collection conduit extends from the head unit through at least a portion of the boom.

28. The system of claim 27 further comprising a spool configured for feeding said collection conduit through said boom during extension of the boom and for receiving said collection conduit during retraction of the boom.

29. The system of claim 23 wherein the boom is mounted to a vehicle.

30. The system of claim 29 wherein the vehicle is a crawler crane.

31. (canceled)

32. The system of claim 23 wherein the head unit is positionable using the boom, the collection conduit being routed separately from the boom so that at least a portion of the collection conduit is not supported by the boom.

33. The system of claim 32 wherein the portion of the collection conduit not supported by the boom is routed to a storage unit.

34. The system of claim 32 wherein the portion of the collection conduit not supported by the boom is connected to a spool so that the head unit may be moved by the boom and collection conduit may be extended from the spool or received by the spool to accommodate for movement of the boom.

35-40. (canceled)

41. The system of claim 23 wherein the boom is mounted to at least one of a platform, barge, floating pontoon, or scaffolding.

42-75. (canceled)

76. A method of in situ extraction of hydrocarbons from a surface pool of hydrocarbons comprising:
lowering a pump head into a surface pool of hydrocarbons, the pump head comprising an intake conduit and a plurality of magnetrons;
heating the hydrocarbons near the intake conduit using microwave energy from the magnetrons;
removing the heated hydrocarbons from the surface pool by use of the pump head; and
moving the pump head in the surface pool.
